(19) United States
(12) Patent Application Publication
(10) Pub. No.: US 2008/0196108 A1
(43) Pub. Date: Aug. 14, 2008

(54) System and method for providing remote users with reports and analyses based on user data and adaptable reporting with the ability to alter, modify or augment such reports and analyses through web-based technology

(75) Inventors: Thomas Dent, Park Ridge, IL (US); Theresa Hush, Chicago, IL (US); William Aube, Chicago, IL (US); Jose Mata, Chicago, IL (US); George Hernandez, Chicago, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: ICLOPS,LLC, Chicago, IL (US)

(21) Appl. No.: 10/713,892

(22) Filed: Nov. 14, 2003

Related U.S. Application Data
(60) Provisional application No. 60/514,220, filed on Oct. 24, 2003.

(51) Int. Cl. G06F 21/00; G06F 17/30

(52) U.S. Cl. 726/28; 707/102; 707/E17.009

(57) ABSTRACT

A system and method for providing remote users with reports and analyses based on user data is disclosed. The reports are adaptable and the remote user can alter, modify, and argument the reports and analyses. Client data is extracted from a client device and other sources. The client data is quantified by analytic definitions. The analytic definitions are an identification of performance measures. The quantified data is queried and grouped according to the analytic definitions. Datamarts are created by separating the grouped data. The datamarts are then converted into on-line analytical processing (OLAP) cubes. The OLAP cubes are then used by the remote user to create adaptable reports. The adaptable reports may be used by practice professionals to understand their business and clinical operations, and to improve business performance and patient care.

### PRIORITY

The present application claims priority under 35 U.S.C. § 119(e) to U.S. Provisional Patent Application Ser. No. 60/514,220 titled “System and Method for Providing Remote Users With Reports and Information Based On User Data and Adaptable Reporting With the Ability to Alter, Modify or Augment Such Reports and Information Through Web-Based Technology” filed on Oct. 24, 2003, the full disclosure of which is incorporated herein by reference.

### FIELD OF THE INVENTION

This invention is directed generally to a system and method of providing reports and analyses through web-based technology, and more particularly to a system and method of providing remote users in the health care or other professional industry, via their computer web browser, with reports and analyses related to their businesses based on data from information systems in a fashion that allows them to alter, modify or augment the contents and presentation of such reports and analyses by the use of a web application utilizing database technology.

### BACKGROUND

The current healthcare environment is placing tremendous financial pressures on physicians and other healthcare businesses. Without the ability to alter the external health care market forces, physicians must use the tools deployed by more traditional businesses to understand how their practices operate and how the market environment is affecting their businesses. Practice success, in large part, depends on access to information such as patient flow, patient satisfaction, physician productivity, contract profitability, operating costs, and clinical quality. These performance measures are not traditionally addressed by in-house systems.

In addition to financial issues, the regulatory and market environment of health care now requires greater clinical understanding and more sophistication in the management of patients with complex clinical problems. Health care enterprises are measured by insurance plans and governmental bodies on their ability to provide quality care to discrete populations, such as diabetic, hypertensive, and asthmatic patients, and to provide screening programs appropriate to age and gender.

Physician practices currently lack the tools needed to efficiently respond to these issues. Typically the only method of compiling financial and market data is through the practice's billing or clinical information systems. Even when used (some practices outsource billing functions), these systems are usually designed for transactional processing and provide limited management reporting and little, if any, practice profile data. For the more sophisticated systems with database repositories and pre-programmed reporting capabilities, programming staff are still required to write and reformat static reports for true analytical purposes, which can be very costly. As a result, practices of all sizes are lacking the information critical to success and sustainability.

Accordingly, there is a need to provide a system and method of supplying practice professionals with critical business analysis capabilities so that they may understand their business operations and improve business performance. There is also a need to assist medical providers in the communication and provision of services to patients and to increase the quality of care provided to patients. It would be useful to provide these capabilities while using data from client practice management systems and other sources of client data, and to insure that all information transferred from one location to another is done so in accordance with the Health Insurance Portability and Accountability Act of 1996 (HIPAA) privacy regulations.

Furthermore, it would be useful to provide businesses with analytical capabilities that are timely, useful and that require little (and preferably no) additional programming by client staff or others and allow users to quickly explore key issues. Ideally, these analytical capabilities would be available over a commonly available resource such as a web browser accessing the Internet or corporate intranet. There is also a need to deliver a user interface that is easy to use, yet capable of answering a variety of queries against the source data, with a system that is capable of providing analytical capabilities to multiple clients using disparate practice management systems.

### SUMMARY OF THE INVENTION

One embodiment of the invention is directed to creating meaningful business and clinical analysis tools based on client data from a client's practice management system, external billing systems, external insurance systems, external pharmacy systems, external laboratory systems, and other sources of client data; and providing such clients at remote locations with web-based access to those tools. At the core of the embodiment is the presence of custom OLAP cubes (processed datamarts) which are built especially to address business and clinical analyses.

The following describes the method of creating the OLAP cubes. Business and clinical performance indicators used by external experts, purchasers of health care, and patients were analyzed and itemized to determine what queries may be needed by a practice. These performance indicators included financial performance measures used by accountants, billing agents, and other organizations assessing the financial health of the customer entity; financial and other measures used by provider contracting organizations in assessing the impact of contracts between health care payers and the customer entity; market performance measures used to assess the growth potential and survivability of the customer entity; productivity and operational performance measures used to determine the efficiency of the operation of the customer entity; and clinical performance measures used to evaluate compliance with established clinical protocols and accepted quality of care guidelines.

Transactional data needed to develop queries that result in the performance analyses are identified and listed. The client data is then combined with the performance identifiers to create a standard dataset for extraction from the sources of client data. The standard dataset is then organized into OLAP datamarts and cubes to create modules, dimensions, and measures by which the performance analysis may be displayed to customers. The result of this process is an analytical tool that can be customized for individual customers, but which contains a model for organizing and displaying analyses of business and clinical performance.

Transactional data from the sources of client data is copied or extracted into a file or set of files. The system that stores these files possesses a client application for encrypted file transfer, and is connected to a transmission system (such as the Internet or a corporate local area network (LAN)) via a first transmit/receive device (such as an Ethernet network interface card (NIC)). Data files are sent from the source system to a host server. Data files are analyzed and a relational database is created. The relational database is further analyzed to determine the possible analytical content. Datamarts are created based on what analytical content is possible, according to the processes previously determined to be heeded by a practice. Datamarts are created to adequately respond to queries in the areas of financial performance, patient flow, patient satisfaction, physician productivity, contract profitability, and clinical quality. Cubes are then created based on the datamarts.

The following describes the method by which a user gains access to the OLAP cubes and makes use of them via a web application. The user logs onto the web page, selects the application, and enters authentication information, which may vary from entering a password to more complex entry authorization protocols. The user may access the web site by using a computer to open a web browser and entering a universal resource locator (URL) for the web server hosting a web application. The web server sends a homepage to the web browser of the user via a transmission system. The user accesses the web application via the web browser, and the web server sends a login form in which the user enters his credentials/password to obtain access.

Once accessed, the web server sends a dynamic custom application page to the user. The user then performs application options, such as alter, modify, and augment the contents of views. In this manner, use of the application enables users to understand their business and clinical operations, and to improve business performance and patient care.

Security against unauthorized access of data as it is passing though the transmission system is ensured by the use of encryption/decryption software as provided by the web server/browser and other file transfer server/client software. This may ensure that only an authorized user can read, transmit, and receive data to and from the application system.

The foregoing and other features and advantages of embodiments of the invention will be apparent from the following more particular description of preferred embodiments as illustrated in the accompanying drawings.

### BRIEF DESCRIPTION OF THE DRAWINGS

An exemplary embodiment of the present invention is described herein with reference to the drawings, in which:

FIG. 1 is a block diagram of a system for data extraction and conversion, according to an exemplary embodiment;

FIG. 2 is a table of data fields for client data, according to an exemplary embodiment;

FIG. 3 is a flowchart of a method of data extraction and conversion using the system depicted in FIG. 1, according to an exemplary embodiment;

FIG. 4 is a block diagram of a system for client access to analytical data, according to an exemplary embodiment;

FIG. 5 is a flow chart of a method of accessing analytical data using the system depicted in FIG. 4, according to an exemplary embodiment;

FIG. 6 is a screen shot of a sample view, according to an exemplary embodiment;

FIG. 7 is a screen shot of practice revenues, according to an exemplary embodiment;

FIG. 8 is a screen shot of patient visits, according to an exemplary embodiment;

FIG. 9 is a screen shot of charges and revenues, according to an exemplary embodiment;

FIG. 10 is a screen shot of charges by financial class, according to an exemplary embodiment;

FIG. 11 is a screen shot of revenues by financial class, according to an exemplary embodiment;

FIG. 12 is a screen shot of collection rates, according to an exemplary embodiment;

FIG. 13 is a screen shot of collection rates by payer, according to an exemplary embodiment;

FIG. 14 is a screen shot of financial data, according to an exemplary embodiment;

FIG. 15 is a screen shot of data shown in FIG. 14 including percent charges of RBRVS, according to an exemplary embodiment;

FIG. 16 is a screen shot of data shown in FIG. 15 by payer, according to an exemplary embodiment;

FIG. 17 is a screen shot of data shown in FIG. 16 by a selected financial class, according to an exemplary embodiment;

FIG. 18 is a screen shot of data shown in FIG. 17 including charges with adjudicated payments, denied charges, and payment lag, according to an exemplary embodiment;

FIG. 19 is a screen shot of financial data, according to another exemplary embodiment;

FIG. 20 is a screen shot of financial data, according to another exemplary embodiment;

FIG. 21 is a screen shot of a number of diabetic patients and a number of visits these patients made to a practice in a given time, according to an exemplary embodiment;

FIG. 22 is a screen shot of data shown in FIG. 21 separated by age category, according to an exemplary embodiment;

FIG. 23 is a screen shot of data shown in FIG. 22 separated by financial class, according to an exemplary embodiment;

FIG. 24 is a screen shot of a number of diabetic patients that also suffer from hypertension, according to an exemplary embodiment;

FIG. 25 is a screen shot listing diabetic patients that also suffer from hypertension and the associated number of visits, according to an exemplary embodiment;

FIG. 26 is a screen shot listing place of service, according to an exemplary embodiment;

FIG. 27 is a screen shot of data shown in FIG. 26 for patients that visited a practice in the last two quarters, according to an exemplary embodiment;

FIG. 28 is a screen shot of data shown in FIG. 27 including date of visit, according to an exemplary embodiment;

FIG. 29 is a screen shot of data shown in FIG. 28 including primary diagnosis, according to an exemplary embodiment; and

FIG. 30 is a screen shot of data shown in FIG. 29, including charge to patient, according to an exemplary embodiment.

### DETAILED DESCRIPTION

### Data Extraction and Conversion

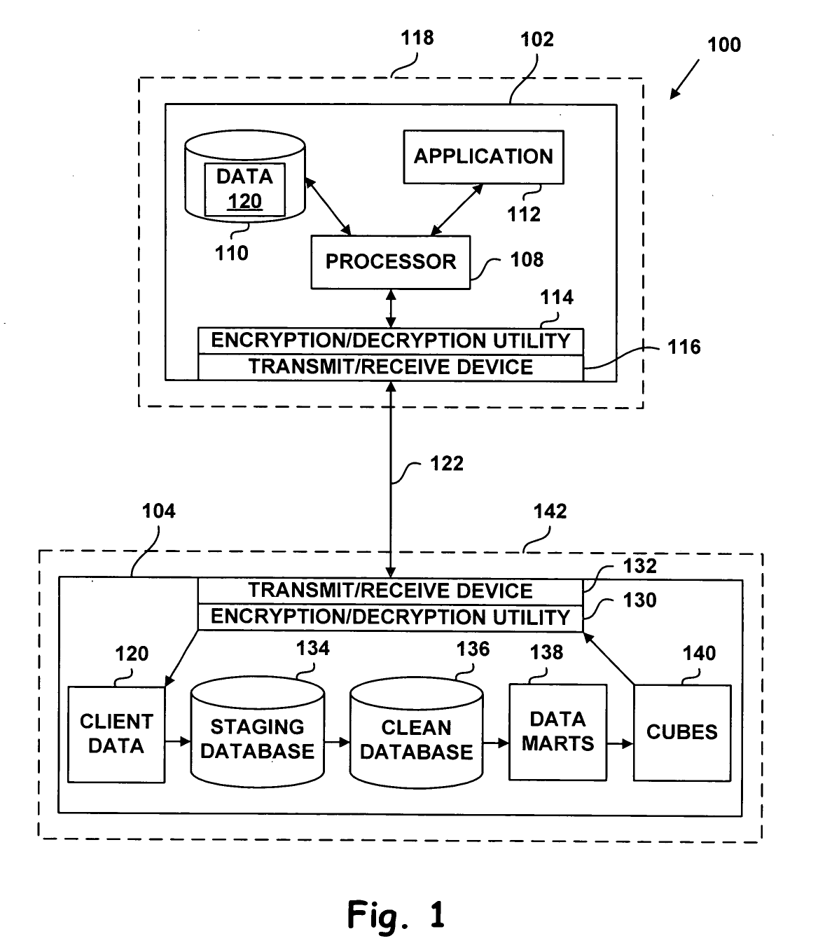

FIG. 1 is a block diagram of a system 100 for data extraction and conversion. The system 100 includes a client server 102 and a database server 104. The system 100 may include additional entities not shown in FIG. 1. Additionally or alternatively, the servers 102,104 may be co-located and/or integrated.

The client server 102 may be a client's source computer system. The client server 102 may include a processor 108, data storage 110, at least one application 112, an encryption/decryption utility 114, and a transmit/receive device 116. The client server 102 may be located behind a client firewall 118. The client server 102 may include additional entities not shown in FIG. 1.

The processor 108 may be a microprocessor suitable for receiving input signals, executing machine language instructions, and providing output signals. The processor 108 may receive input signals internally, such as from the data storage 110. Additionally or alternatively, the processor 108 may receive input signals externally using the encryption/decryption utility 114 and the transmit/receive device 116. The application 112 may include machine language instructions executed by the processor 108. The processor 108 may provide the output signals to entities within the client server 102, such as the data storage 110. Alternatively, the processor may provide the signals to an external entity, such as the database server 104, using the encryption/decryption utility 114 and the transmit/receive device 116.

The data storage 110 may comprise one or more volatile and/or non-volatile storage mechanisms, such as random-access-memory (RAM), flash memory, an optical disk drive, a magnetic disk drive, and so on. Client data 120, in the form of a file or set of files that contain details of client transactions, may be stored in the data storage 110. Additionally or alternatively, some or the entire client data may be stored one or more other servers. For example, the client data 120 may be stored on an external billing, insurance, pharmacy, and/or laboratory system.

The client data 120 may be stored in the data storage 110 in a table format. The client data 120 may include customer/patient demographic information and transactional details, such as charges, payments, payment sources, diagnoses, services rendered, service provider, and so on.

The application 112 may be a software program, such as a practice management system, used by the client. The application 112 may facilitate the collection of client data 120 that is stored in the data storage 110. For example, the application 112 may display a form on a computer display that enables a user to enter client data 120 to be stored in the data storage 110. The same or a different application 112 may be used to generate reports for the client. The reports may include some or the entire client data 120 stored in the data storage 110.

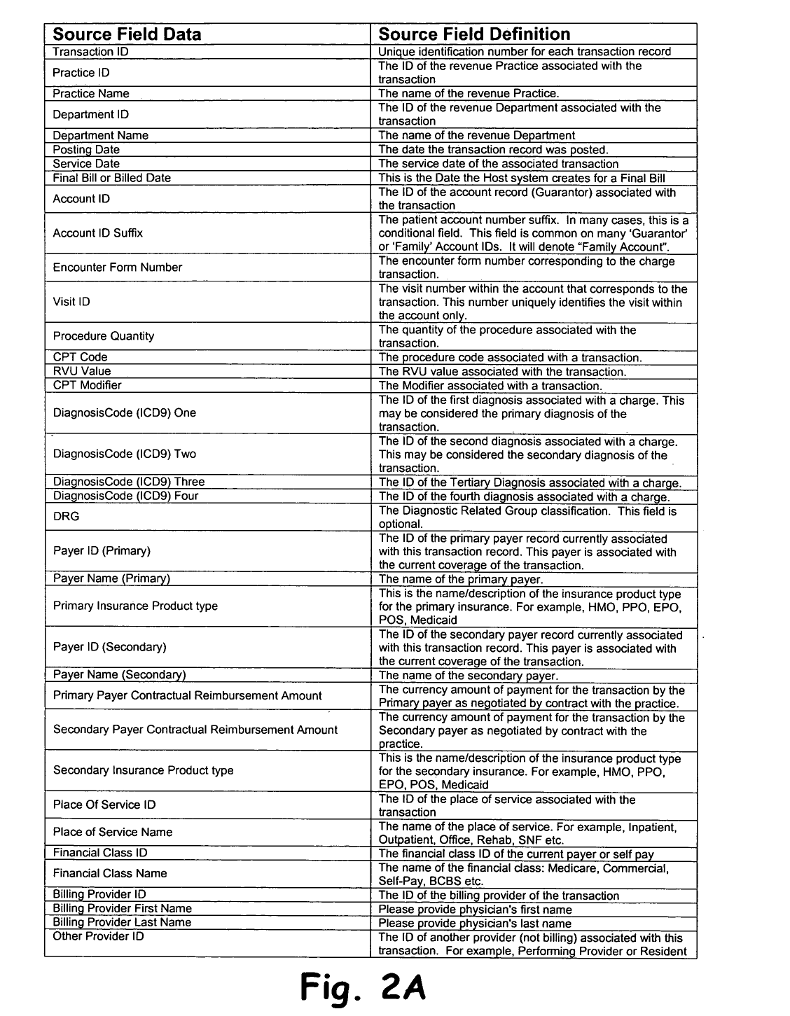

FIGS. 2A-2B is a table of data fields for the client data 120, according to an exemplary embodiment. The first column, “Source Field Data,” includes the types of data in a data field, while the second column, “Source Field Description,” includes a definition of the client data associated with the data field. Additional data fields may be included in the table. As seen in the table, the client server 102 may collect client data 120 regarding the practice, the patient, the diagnosis, insurance, and other transactional information regarding a patient's visit to a physician's office.

Referring back to FIG. 1, the encryption/decryption utility 114 may be used to ensure data security for both transmitted and received data. For example, the encryption/decryption utility 114 may be a secure shell (SSH) utility. However, other encryption/decryption methods may be used to allow the client server 102 to securely transmit and receive data over a network, such as a local area network (LAN), a wide area network (WAN), intranet, and the Internet. Alternatively, the client may copy the client data 120 stored on the data storage 110 onto a physical medium, such as a magnetic storage device or an optical storage device, and deliver the physical medium to a user of the database server 104.

The transmit/receive device 116 may allow data to be transmitted and received over a network. For example, the transmit/receive device 116 may be an Ethernet network interface card (NIC). The transmit/receive device 116 may allow the client data 120 to be transmitted and received over network 122. The client firewall 118 may prevent unauthorized entities attached to the network 122 from obtaining the client data 120. The network 122 may provide a communication pathway between the client server 102 and the database server 104. The network 122 may be a LAN, WAN, intranet, or Internet. In another embodiment, the client server 102 and the database server 104 may be co-located and/or integrated and the network 122 may be unnecessary to transfer client data between the client server 102 and the database server 104.

The database server 104 may receive client data 120 from the client server 102 or other external sources using an encryption/decryption utility 130 and a transmit/receive device 132. The encryption/decryption utility 130 may be a SSH utility. However, other encryption/decryption methods may be used to allow the database server 104 to securely transmit and receive data over the network 122. The transmit/receive device 116 may be an Ethernet NIC. The transmit/receive device 132 may allow data to be transmitted and received over the network 122.

The database server 104 may be a computer designed to extract and convert client data 120 that was originally stored on the client server 102 or other system. For example, the database server 104 may receive client data 120 from external billing systems, insurance systems, pharmacy systems, laboratory systems, and other sources. The database server 104 may be running a database program, such as Microsoft SQL. Upon receipt of the client data 120, the database server 104 may create a temporary staging database 134. The temporary staging database 134 may be a tabular or relational database that includes some or the entire client data 120.

The contents and details of the client data 120 in the temporary staging database 134 may be quantified and mapped. The contents of the client data 120 may be quantified based on analytic definitions. The analytic definitions are an identification of what questions a practice may ask to further understand their business and clinical operations, and to improve business performance and patient care. For example, the analytic definitions may be performance measures used to gauge a practice. Some of the analytic definitions used by the system 100 are listed below. The analytic definitions are grouped by financially focused analytic definition examples and clinically focused analytic definition examples.

### Financially Focused Analytic Definition Examples

Accounts Receivable (AR) Levels:
Assess if outstanding AR is at a reasonable level
Assess days in outstanding AR (AR level as a function of monthly charges)
   Absolute level of AR vs. monthly charges
   Quantify one-time cash flow savings by having AR at 60 days for insurance payments (payment lag from charge post or billing date)
Determine if the AR trend increasing or declining, By how much

Collections (billing perspective):
Determine the collection rates by financial class and by payer, on charge base and on Resource-Based Relative Value Scale (RBRVS) (RBRVS linked to appropriate schedule for date of service and location of practice)
Determine the denial rates and reasons:
   By Provider
   By Payer
   By Location
   By Current Procedural Terminology (CPT) Code
Determine the total discount, aggregate and by payer
Determine the adjustments and write-offs by reason and by time
Determine the payment lag (days from charge post to payment post)

Coding:
For primary care, determine if Evaluation and Management (E&M) coding is within expected levels.
   By Provider
   By Practice
What is the revenue opportunity for each CPT code?

Front-end billing processes:
Quantify charge lag
   Determine the number of days by place of service
   Determine the number of days by Provider
   Quantify one-time revenue savings by speeding up processes from benchmark
Determine the quality of payer data (see Other Processes below)
Identify the eligibility-related denials
Identify the covered benefits-related denials
Determine issues related to charge capture (comparison of visits vs. billing)
Determine fee schedule quantities (comparison with RBRVS in total and by CPT)

Payer values:
Determine payer mix/reimbursement rate impact
   How overall practice collection rate is driven by collection rates by financial class and, for insurance payers, by individual payers. The end analysis should produce an “ideal” payer mix configuration model for increasing revenues by shifting patient mix into financial classes and payers with higher levels of reimbursement.
Observe varying collection rates, denial rates, and contractual allowances by payer and financial class
   Displays problem payers by first identifying low collection rates based on adjudicated charges (not just posted receipts), and then filters for denial levels/reasons and contractual allowances)
Compare payer reimbursement levels (dollar levels for top CPTs and RBRVS value for top CPTs)

Other Drivers for Practice Revenues:
Determine reimbursement rates per place of service, compared with mix of place of services
   Are services being delivered most productively in settings? (e.g., many services in hospitals and nursing homes—should be stated as $ per place of service-type as well as overall % of visits, charges, and revenues)
Determine visit volumes and reimbursements by physicians and locations
Quantify new visit volumes as % of total visits (by CPT)
Determine service mix (CPTs) and revenues by top CPTs
Quantify patient collections: Copays and days in AR for patients

Other Billing Processes and data problems
Observe denial reasons lists (too many/overlapping/not entered)
Observe payer list (duplicate payers/no product type notation/mix of payer guarantors and payers of coverage/missing payers)
Determine place of service listings
Assess patient billing processes (copays, payment at time of visit)

Clinically Focused Analytic Definition Examples
Identify patients for follow-up, and work with practice to effect their return
   With a disease state that requires visits at a regular established frequency (e.g., diabetes)
   As established by a return visit in a given time frame requested by the physician (and recorded in the practice management system).
Identify patients with risk factors for testing or referral, and develop strategy to address
   Age (e.g., >50 years old for colonoscopy)
   Gender (e.g., pap smears, PSA)
   Disease state (e.g., Hgb AIC for diabetics)
   Family history (e.g., abdominal aortic aneurysm for ultrasound of abdomen)
Identify patients with concerning diagnoses or procedures or patients with multiple diagnoses reflecting significant morbidity plus numerous visits
   Perform a chart review where no follow-up is obvious or has not occurred in a timely fashion
   Meet with physician to address contacting these patients
Analyze referrals for consulting physicians and work with physicians to favorably enhance the number and value of referrals
   Determine trends
   Assess importance of different referral sources
   Determine location of referrals (inpatient vs. outpatient) for different referral sources, compare and contrast differences among different referring physicians.
Determine clinical experience from different payer sources
   Calculate numbers of patients with selected diagnoses for individual payers
   For consulting physicians trend selected procedures and diagnoses for individual payers
Determine adherence to series of quality measures (e.g., Hedis) for practices and individual physicians
Determine geographic distribution of patients with different procedures and financial impact
Track patients for lack of completion of ordered laboratory tests and referrals, determine composition of this population for interventional strategies

The content of the data in the temporary staging database 134 may be analyzed to locate sets of information required by the analytic definitions. Typically, a practice management system may store the different types of data separately. For example, the following data types may be stored separately: charges, payments, appointments, aging accounts receivable, and clinical records. The identification of tables and fields need for the analytic definitions may be performed manually or by using a database schema document. Inconsistencies, such as erroneous data types, may be isolated and/or corrected while the client data 120 is in the temporary staging database 134.

The database server 104 may create a clean database 136. The clean database 136 may be created by identifying the relevant sets of data in the temporary staging database 134 and disregarding the non-relevant data sets. The relevant sets of data are then copied to the clean database 136. The clean database 136 may be used to further explore the contents of the client data 120.

Within the clean database 136, queries may be executed to group sets of data together in ways dictated by the analytic definitions. For example, a query may be performed that analyzes the CPT codes found within each transaction and categorizes these transactions by where services were provided. This new categorization may allow the practice to see how many patients have been treated in an office, a hospital, or a nursing home. As another example, a query may be performed that analyzes diagnosis codes and categorizes by diagnosis. This new categorization may allow a practice to see how many diabetic (or any other chronic condition) patients they are treating. Other queries may be performed that locate and correct null values in records, which may have “orphaned” the records.

Once the clean database 136 has been explored, the clean database 136 may be used to separate the data in the clean database 136 into smaller, related groups of data, herein referred to as datamarts 138. The datamarts 138 may be created by separating the client data 120 according to requirements of the analytic definitions. For example, one datamart 138 may include financial information, while another datamart 138 may include scheduling information. By separating the client data 120 into datamarts 138, the datamarts 138 may be queried to provide concise, meaningful analyses to a client. These analyses may be performed using a standard set of data. However, customized analysis may be performed using a client's unique data or needs. For example, the datamarts 138 may include information relevant to revenue cycles, the flow of customers/patients of specific interest, and/or any other analysis desired by the client.

The datamarts 138 may be processed into multidimensional databases called cubes 140. The datamarts 138 may be processed into cubes 140 using an on-line analytical processing (OLAP) engine, such as Microsoft Analysis Services. OLAP engines may perform multidimensional expression (MDX) analysis of data, including complex calculations, trend analysis, and modeling. Those skilled in the art are familiar with the operation of OLAP engines.

The cubes 140 may be constructed to provide adequate capacity to analyze financial trends of the practice, payer contract assessment, patient volume and trends, physician-specific activity, clinical volume and trends, and patient population tracking and trends. These cube areas are listed below.

1. Financial Cube: Financial trends of the practice
a. Analysis of financial activity by dates of service and posting dates
b. Aged accounts receivable
c. Charge posting lag
d. Payment lag from date of billing
e. Payer mix and by-payer reimbursements
f. Collection rates, contractual allowances, and denied charges
g. Denial reasons
h. RBRVS-benchmarked collections and payments
i. Procedure coding
j. Other drivers for practice revenues: place of service efficiencies, service mix by CPT, lab reimbursements and costs

2. Payer Cube: Payer Contract Assessment
a. Patient mix by payer
b. By-payer collection results (charge-based and RBRVS), denials, payment lags, and total discount
c. Payment variability between payer fee schedule and payment level

3. Patient Cube: Patient volume and trends
a. Zip code and demographic trends
b. New visit growth trends
c. Patient age groupings

4. Physician Cube: Physician-Specific Activity
a. Activities sorted by physician, location, CPT and CPT groupings
b. By-physician and by-location charges, revenues, procedure coding
c. Office appointment through-put by location and physician

5. Clinical Cube: Clinical Volume and Trends
a. E & M coding and procedural activity
b. Patient listings for diagnoses of concern
c. Referral source trends by type of cases and aggregated severity

6. Electronic Medical Records (EMR) Cube: Patient Population Tracking and Trends
a. Medication filters, including grouped indicators by class (e.g. Angiotensin-Converting Enzyme (ACE) inhibitors)
b. Blood pressure trending and variation, by physician and by person-performing
c. Lipid result trending and variations by location, physician, and medication or combination of medications
d. Filters or trends for other laboratory results, e.g. C-reactive protein or other inflammatory markers
e. Use of aggregate CPTs to assess groups of patients with particular procedures to time-trend other complications or interventions
f. Use of genetic and patient history information to track outcomes related to disease.
   Not all clients will need to generate all the cubes 140 identified above. However, additional cubes 140 may also be generated.

Once the cubes 140 are generated, the cubes 140 may be stored. The cubes 140 may be stored on the database server 104. Alternatively, the cubes 140 may be stored at an offsite datacenter. In the datacenter embodiment, the cubes 140 may be transmitted to the client server 102 or another server via a network, such as network 122. The cubes 140 may be transferred using an encryption/decryption utility, such as SSH. Alternatively, the cubes 140 may be transferred to a datacenter by copying the cubes 140 onto a physical medium, such as a magnetic storage device or an optical storage device, and delivering the physical medium to the datacenter.

The database server 104 may be located behind a service firewall 142. The service firewall 142 may prevent unauthorized entities attached to the network 122 from obtaining the client data 120 or converted client data.

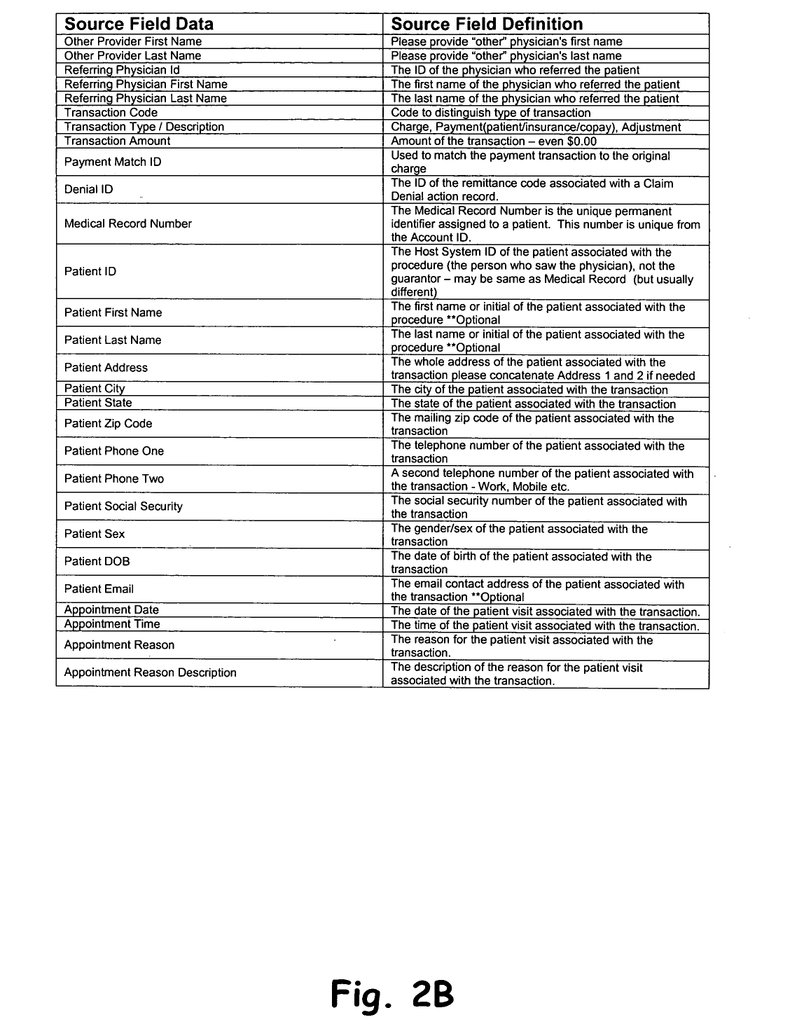

FIG. 3 is a flowchart of a method 300 for data extraction and conversion, according to an exemplary embodiment. The method 300 is explained with reference to the system 100 depicted in FIG. 1. The method 300 may also include additional steps not depicted in FIG. 3.

At block 302, client data 120 may be received by the database server 104. The client data 120 may be in the form of a table. For example, the client data 120 may include the types of data depicted in FIGS. 2A-2B. At block 204, a temporary staging database may be created. The temporary staging database 134 may be a tabular or relational database that includes some or the entire client data 120.

At block 306, client data 120 may be quantified and mapped. The contents of the client data 120 may be quantified based on analytic definitions. The analytic definitions are an identification of what questions a practice may ask to further understand their business and clinical operations, and to improve business performance and patient care. The content of the data in the temporary staging database 134 may be analyzed to locate sets of information required by the analytic definitions. The identification of tables and fields need for the analytic definitions may be performed manually or by using a database schema document. Inconsistencies, such as erroneous data types, may also be isolated and/or corrected while the client data 120 is in the temporary staging database 134.

At block 308, a clean database 136 may be created. The clean database 136 may be created by identifying the relevant sets of data in the temporary staging database 134 and disregarding the non-relevant data sets. The relevant sets of data are then copied to the clean database 136. The clean database 136 may be used to further explore the contents of the client data 120.

At block 310, datamarts 138 may be created. The datamarts 138 may be created by separating data in the clean database 136 according to requirements of the analytic definitions. By separating the client data 120 into datamarts 138, the datamarts 138 may be queried to provide concise, meaningful analyses to a client. For example, the datamarts 138 may include information relevant to revenue cycles, the flow of customers/patients of specific interest, or any other analysis desired by the client.

At block 312, cubes 140 may be created. The datamarts 138 may be processed into cubes 140 using an OLAP engine. The cubes 140 may be constructed to provide adequate capacity to analyze financial trends of the practice, payer contract assessment, patient volume and trends, physician-specific activity, clinical volume and trends, and patient population tracking and trends.

### Accessing Analytical Data

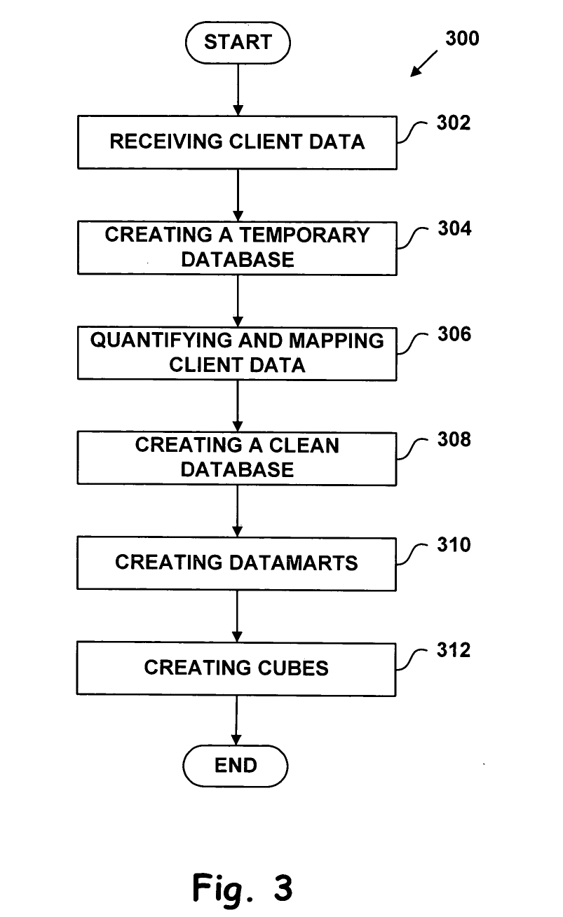

FIG. 4 is a block diagram of a system 400 for client access to analytical data, according to an exemplary embodiment. The system 400 includes a client device 402, a web server 404, and a database server 406. The system 400 may include additional entities not shown in FIG. 4. Additionally or alternatively, the servers 404, 406 may be co-located and/or integrated.

The client device 402 may be a computing device or a terminal connected to a computing device. The client device 402 includes a web browser 408, output devices 410, input devices 412, a processor 414, an encryption/decryption utility 416, and a transmit/receive device 418. The client device 402 may include additional entities not depicted in FIG. 4. The client device 402 may allow a user of the client device 402 to remotely access analytical data.

The web browser 408 may be an application that allows web pages to be viewed by the user of the client device 402. The web browser 408 may fetch a web page that is requested by the user, interpret the text, format commands within the text, and then properly display the web page on a screen. For example, the web browser may be Netscape or Explorer. Those skilled in the art are familiar with the operation of web browsers.

The processor 414 may be a microprocessor suitable for receiving input signals, executing machine language instructions, and providing output signals. The processor 414 may receive inputs from entities within the client device 402 or from external sources via the input devices 412. The input devices 412 may include any device that provides inputs to the client device 402, such as a keyboard, microphone, or mouse. The processor 414 may be operable to execute commands from the web browser 408 and/or other applications on the client device 402. The processor 414 may provide outputs to entities within the client device 402 or to external sources using the output devices 410. The output devices 410 may be any device that provides an output to a user of the client device, such as a monitor or printer.

The encryption/decryption utility 416 may be used to ensure data security for both transmitted and received data. For example, the encryption/decryption utility 416 may be a SSH utility. However, other encryption/decryption methods may be used to allow the client device 402 to securely transmit and receive data over a network, such as a LAN, a WAN, intranet, and the Internet.

The transmit/receive device 418 may allow data to be transmitted and received over a network. For example, the transmit/receive device 418 may be an Ethernet NIC. The transmit/receive device 418 may allow a user of the client device 402 to request and receive analytical data. A network 420 may provide a communication pathway between the client device 402 and the web server 404. The network 420 may be a LAN, WAN, intranet, or Internet.

The web server 404 may be a computer connected to an intranet or the Internet that stores and displays documents and files. The web server 404 may include a web application 422, an encryption/decryption utility 424, a first transmit/receive device 426, and a second transmit/receive device 428. The web server 404 may include additional entities not depicted in FIG. 4.

The web application 422 may be a software application that is operable to select and display appropriate web pages on the client device 402. The web application 422 may receive a request from the web browser 408 for a web page. The web application 422 may respond to the request by verifying the user's authorization to have access to the web page, and if authorized, providing the requested web page to the web browser 408. The web application 422 may receive the request for a web page and respond to the request using the encryption/decryption utility 424 and the first transmit/receive device 426.

The encryption/decryption utility 424 may be used to ensure data security for both transmitted and received data. For example, the encryption/decryption utility 424 may be a SSH utility. However, other encryption/decryption methods may be used to allow the web server 404 to securely transmit and receive data over the network 420.

The first transmit/receive device 426 may allow data to be transmitted and received over the network 420. The second transmit/receive device 428 may allow data to be transmitted and received over a network 430. For example, the first transmit/receive device 426 and the second transmit/receive device 428 may each be an Ethernet NIC.

The network 430 may provide a communication pathway between the web server 404 and the database server 406. In a preferred embodiment, the network 430 is a LAN; however, the network 430 may be a WAN, intranet, or Internet. In another embodiment, the web server 404 and the database server 406 may be co-located and/or integrated and the network 430 may be unnecessary.

The database server 406 may be substantially the same as the database server 104 depicted in FIG. 1. In addition to the entities depicted in FIG. 1, the database server 406 includes a system management database 432. The system management database 432 may include client authorization data. The client authorization data may include a database record associated with each authorized user that indicates which menus (lists and categories of views attributed to the specific user), views (OLAP queries, specifically MDX queries, already written and attributed to the user), databases, and overall content is available to the user with those credentials. Additionally, the database record may include a query code associated with each client that specifies an initial web page to be displayed to the client upon successful credential verification.

The web server 404 and the database server 406 may be located behind a service firewall 434. The service firewall 434 may prevent unauthorized entities attached to the network 420 from obtaining the analytical data.

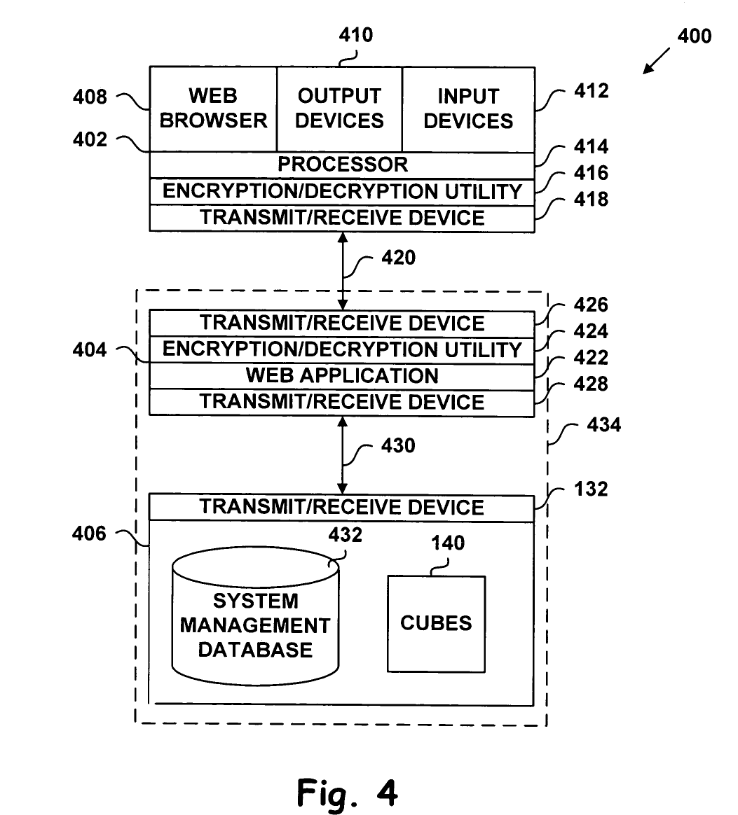

FIG. 5 is a flow chart of a method 500 of accessing analytical data using the system depicted in FIG. 4, according to an exemplary embodiment. The method 500 is explained with reference to the system 400 depicted in FIG. 4. The method 500 may also include additional steps not depicted in FIG. 5.

At block 502, the user may access a web page. The user may use a universal resource locator (URL) to access the web page. The web page may be associated with the database server 406. The web server 404 may transmit the proper web page to the user. The user may click on publicly available links on the web page and the web server 404 may produce the selected pages to be displayed on the client device 402.

At block 504, the user may request access to analytical data. The user may click on a link to logon into the web application 422. The web server 404 may transmit a page containing a logon form. This transmission may be encrypted by the web server 404 and decrypted by the web browser 408 on the client device 402. The user may enter authorized logon credentials into the logon form and submit the form. This transmission may be encrypted by the web browser 408 on the client device 402 and decrypted by the web server 404.

At block 506, the web server 404 may verify the user's credentials. The web server 404 may access the system management database 432 and compare the user's credentials with the system management database 432. If the user's credentials do not match those in the system management database 432, the web server 404 may re-transmit the logon form with an appropriate error message so the user may try again.

At block 508, the web server 404 may determine the extent of the user's access to the analytical data. If the user's credentials match those of a record within the system management database 432, the web server 404 may determine what content the user has access to by reading from the database record associated with the user. The database record associated with the user may dictate which menus (lists and categories of views attributed to the specific user), views (OLAP queries, specifically MDX queries, already written and attributed to the user), databases, and overall content is available to the user with those credentials.

At block 510, the web server 404 opens the appropriate view for the user. The web server 404 may select from the system management database 432 the query code that queries the proper cube 140 to generate the opening view as seen by the user. The web server 404 queries the cube 140 on the database server 406 with the query code. The database server 406 (or the offsite datacenter) may transmit the query results to the web server 404. The web server 404 may send to the user's browser 408 a dynamically built web page containing the dropdown menus and initial/opening view specifically assigned to that user as well as a list of fields illustrating the contents of the cube being used by that view. This transmission may be encrypted by the web server 404 and decrypted by the user's browser 408 on the client device 402.

At block 512, the user may perform several actions within the web application 422 at this point. For example, the user may:
a. Select and open another pre-written view from the user menu. The user may move the mouse cursor to the menu categories and a predefined list of views may descend. The user may then click on the view title and the method 400 may be repeated except that the web page displayed on the user's client device may be based on the query associated with the view selected.
b. Regenerate the current pre-written view. The user may move the mouse cursor to the “Restore” button and click on the Restore button to have the currently selected view regenerate to a default configuration.
c. Display the query code that was used by the system to generate the view. The user may move the mouse cursor to the “MDX” button and click on the MDX button to have the query code for the current view configuration appear in a separate application window.
d. Send the contents of the view to ExcelView. The user may move the mouse cursor to the “Excel” button and click on the Excel button to have the contents of the current view configuration export into a web-based version of Microsoft Excel, where all the functions of that product may be utilized.
e. Hide or unhide the Field List. The user may move the mouse cursor to the “Fields” button and click on the Fields button to hide or unhide the Field List.
f. Modify the current view using Measures and Dimensions from the Field List. The user may click on a folder in the Field List and add new Dimensions (fields) or Measures to the view in a “drag and drop” manner. In this process, the web application 322 may dynamically create a new MDX query that is run against the cube 140. The method 400 may be repeated except that the view that appears is based upon the results of the newly altered MDX query.
g. Save a modified view for later use. The user may move the mouse cursor into the menu bar on the “My Views” heading and add the current view to the user menu by clicking “Add View.” This process may add the MDX query code for the current view into the system management database 332 to be incorporated into the user's view menu.
h. Exit the application. The user may terminate the browser session by closing the application window.
   The user may perform additional actions as well.

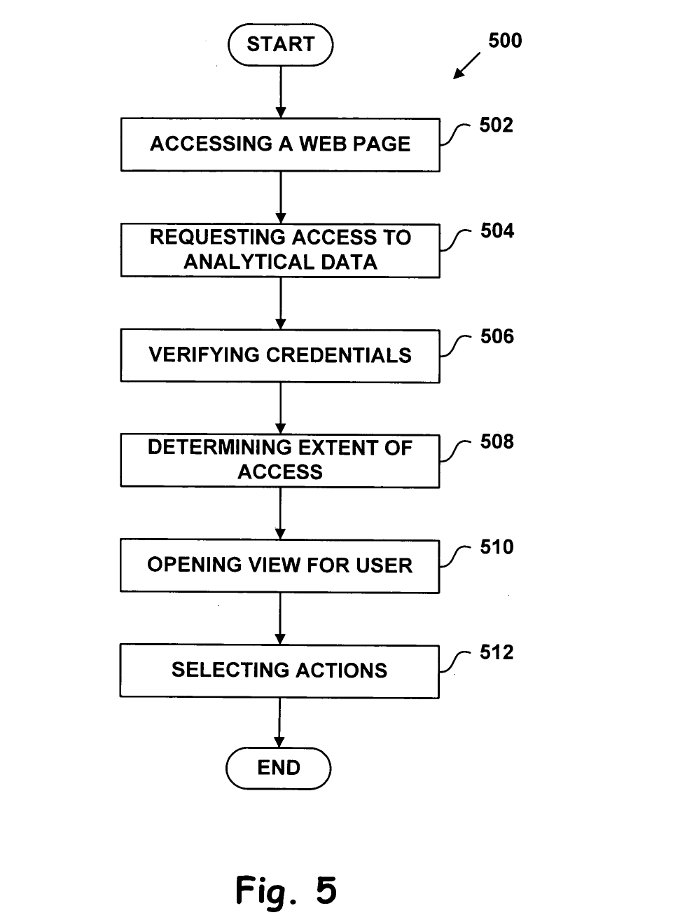

FIG. 6 is a screen shot of a sample view, according to an exemplary embodiment. This view may be used to explain how the user may perform the actions listed above with reference to block 512 within the web application 422. The user may select and open another pre-written view by selecting an analysis module 626 on the menu bar 602. For example, the user may select the physician module. A drop down menu of initial views 628 for that analysis module 626 may appear. The user may then select an initial view 628 as a starting point of an analysis.

The user may regenerate the current pre-written view by clicking the restore button 604. This feature may be useful if the user wishes to begin a new analysis or provide a known starting point. The user may display the query code by clicking on the MDX button 606. The user may review the query code to determine what query the system 300 is performing. The user may send the contents of the view to Excel by clicking the Excel button 608. Once the data is exported to Excel, the user may use the features within Excel to perform data manipulations, such as creating graphs and charts.

The user may hide or expose a field list 634 by clicking the Fields button 610. The fields list 634 may include measures 630 and dimensions 632, which may be selected by the user to modify the view. By hiding the field list 634, the application 422 may have more workable space.

The user may modify the current view by clicking on a folder in the field list 634 and dragging a new measure 630 or dimension 632 into a Columns Area 618, a Rows Area 620, or a Filter Area 622. The measures 630 may be quantities generated from the data. For example, the measures 630 include counts (e.g., patients, visits, days) and currency (e.g., payments, charges, adjustments). The measures 630 may be calculated and presented in accordance with the analytic definitions.

The dimensions 632 may be categories of data in which the measures 630 may be viewed. The dimensions 632 may allow the user to group measures 630 in logical ways, which may provide the user with analytical information. The dimensions 632 may be hierarchically designed to allow very fine granularity to distinguish data. The dimensions 632 may be built to meet the requirements of the analytical definitions.

The user may save a modified view by selecting My View 614, and clicking on Add View from a drop down menu. The user may exit the application by clicking on the Exit button 616 to close the application window.

### Declining Practice Revenues Example

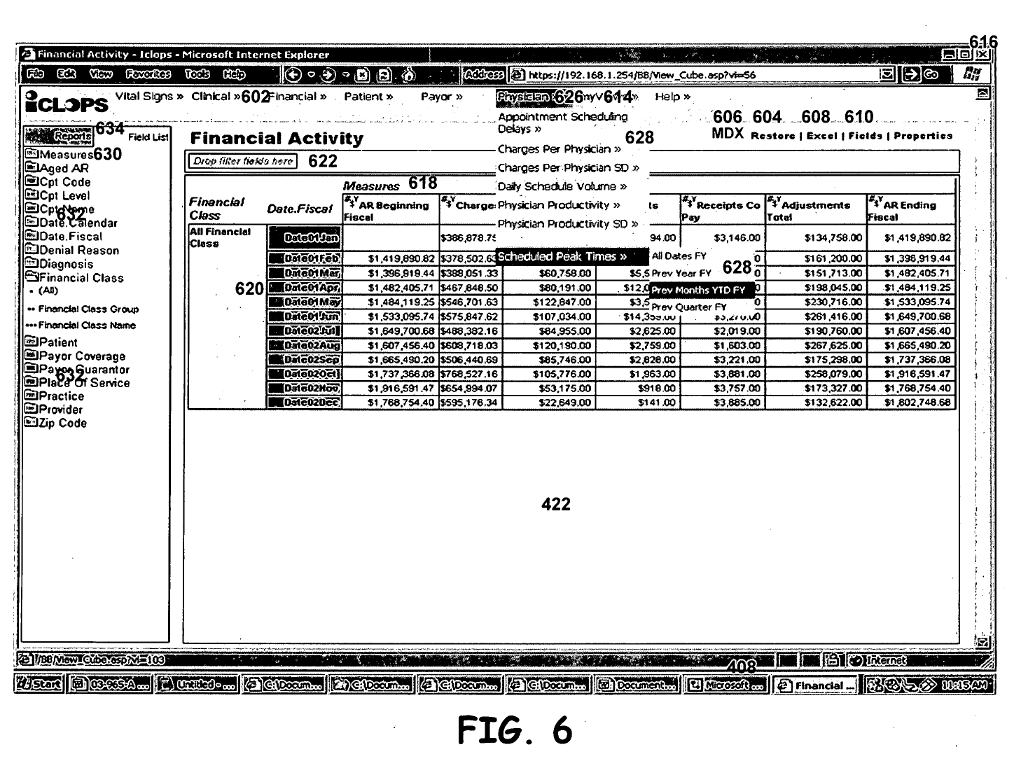

FIGS. 7-13 are screen shots of sample views of results using the system 400 depicted in FIG. 4. Lacking information on performance trends and not knowing where to find the information is one of many problems faced by practices today. For example, a practice may have difficulty determining the source, or even the existence, of declining practice revenues. As described below with reference to FIGS. 7-13, the system 400 may provide a practice with the ability to track the source of revenue changes. It is understood that the data displayed in the screen shots is not actual data, but a representation of the type of data that may be used to analyze the problems encountered by practices.

FIG. 7 is a screen shot of practice revenues, according to an exemplary embodiment. This view may be created by dragging the Revenues Measure into the Columns Area, and the Month level of the Date Fiscal dimension into the Rows Area. The result may be a view that answers the initial question of whether the revenues are in decline or not. The numbers shown in FIG. 7 do indicate that the monthly revenues for this practice are down over 10% for the twelve month period shown.

After reviewing the results depicted in FIG. 7, a practice may now have the information that the practice has experienced a revenue decline. The practice may then want to know why there has been a revenue decline and what the practice do to change the trend, if anything. The system 400 may be used to evaluate different factors to determine the cause of the revenue decline. For example, the system 400 may be used to determine if the revenue decline is a result of the practice treating fewer patients.

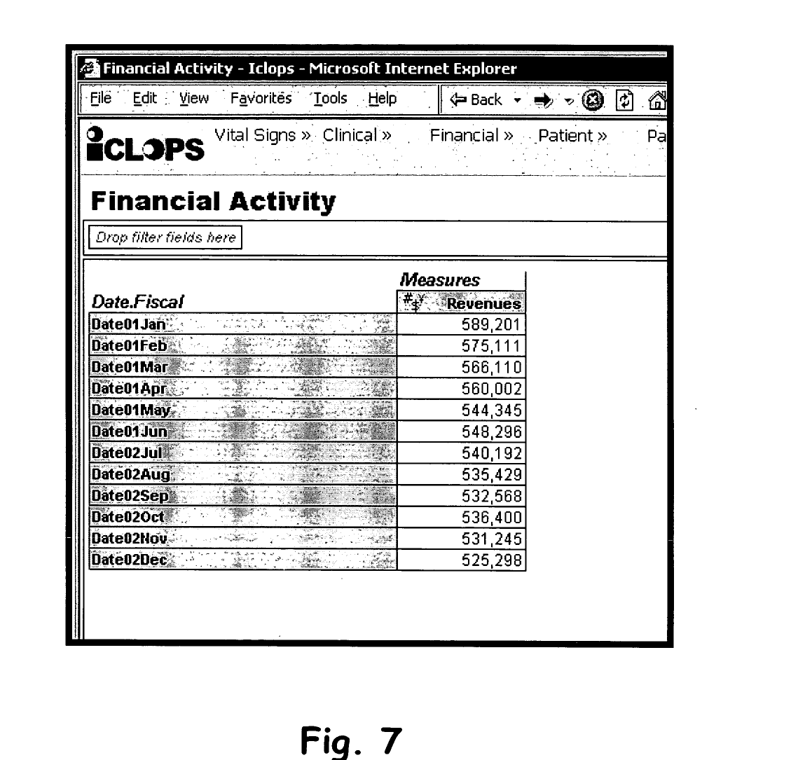

FIG. 8 is a screen shot of patient visits, according to an exemplary embodiment. This view may be created by dragging the Revenues Measure out of the Columns Area and dragging the Patient Visits measure into the Columns Area. The resulting view depicted in FIG. 8 shows that the number of visits has been stable for the time period in question. Since the number of patient visits is stable, that factor may be ruled out as a contributor to the declining revenue. It may be helpful to determine if the practice is charging less overall for its services.

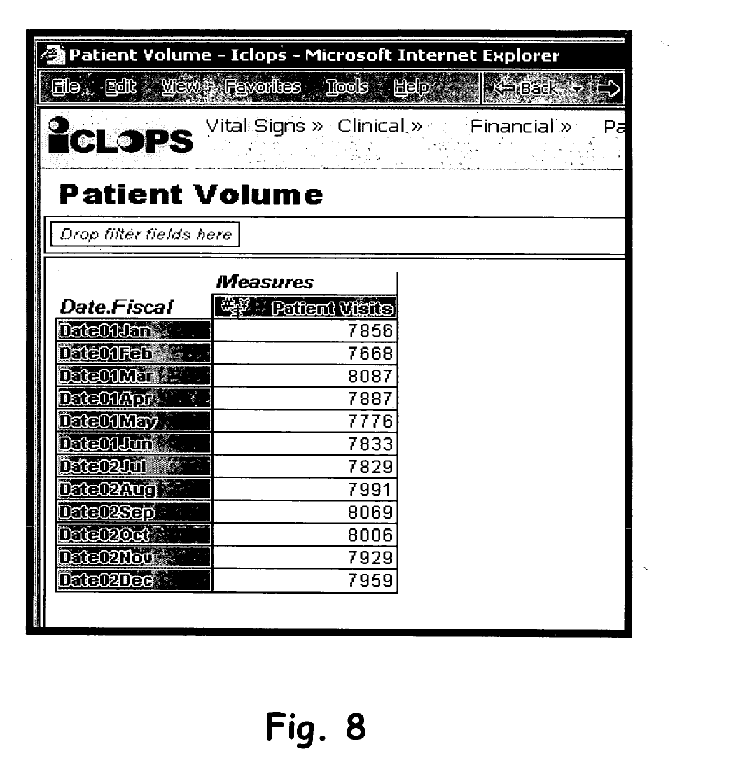

FIG. 9 is a screen shot of charges and revenues, according to an exemplary embodiment. This view may be created by dragging the Patient Visits measure out of the Columns Area and dragging the Charges and Revenues measures into the Columns Area. The resulting view depicted in FIG. 9 shows the charges and revenues side by side, and indicates that charges have been stable for the time period in question. Since the charges for services have remained on average unchanged, the cause of the declining revenue now appears to be within the payment and collection process of the practice. Since some types of payers reimburse the practice at different rates, it would be beneficial to investigate if the mix of payer types has changed in the given period.

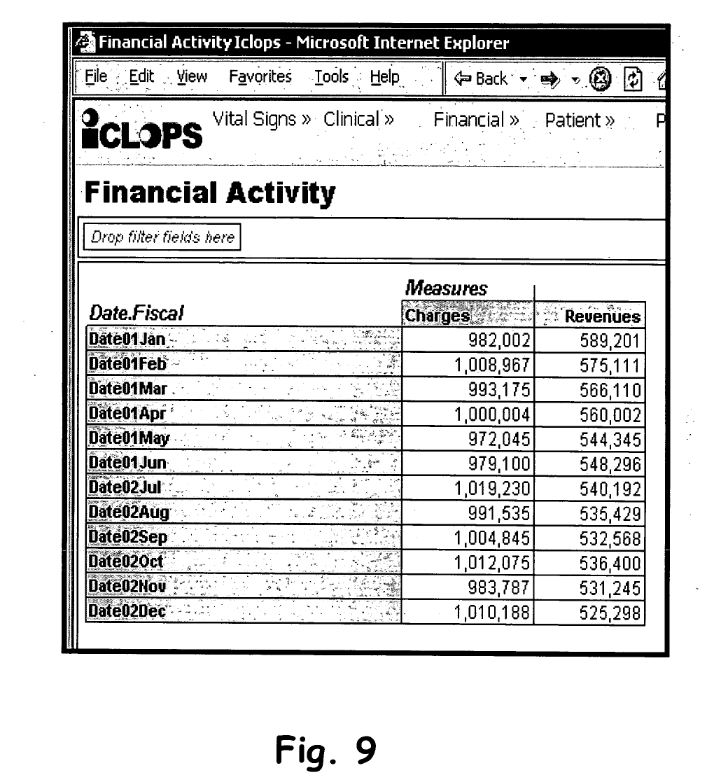

FIG. 10 is a screen shot of charges by financial class, according to an exemplary embodiment. This view may be created by dragging the Revenues measure out of the Column Area and dragging the Financial Class dimension into the Columns Area. The resulting view depicted in FIG. 10 shows charges for services across the various financial classes for the time period. Financial classes are convenient way to group similar types of insurance plans together. By expanding out the financial class members, the practice can see that the charges for the payers in the Insurance PPO category (circle added) have increased by 50% while charges for other categories have either remained stagnant or dropped sharply. This trend may indicate that payers in the Insurance PPO financial class have become a much more significant component of overall charges, starting at 37% of charges and growing to 55% of charges by the end of the period. It may be helpful to determine if the revenue trends match the trends for charges.

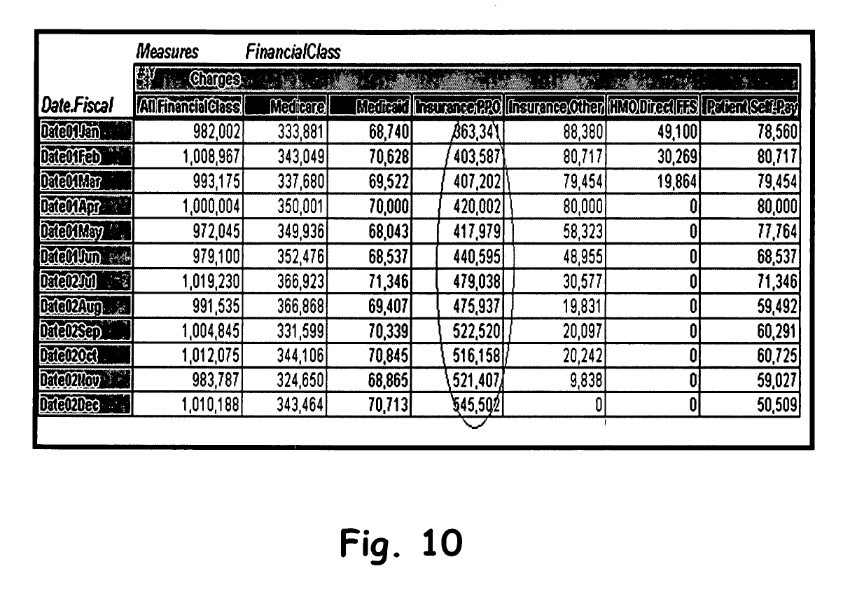

FIG. 11 is a screen shot of revenues by financial class, according to an exemplary embodiment. This view may be created by dragging the Charges measure out of the Columns Area and dragging Revenues measure into the Columns Area. The resulting view depicted in FIG. 11 shows revenues across the various financial classes for the time period, and may be created to reveal any correlation with the charge trend. The charges had risen significantly for the payers in the Insurance PPO financial class, but the revenues are fairly stagnant and have increased by only 8%. Other financial classes show steep drops in revenues that match with the charges trend observed earlier.

From the information presented in the view depicted in FIG. 11, the practice may question whether the revenue decline may be caused by factors related to payers in the Insurance PPO financial class. However, there may be other reasons for the revenue decline. For example, a problem may exist in processes at the billing service, affecting collections. As another example, a problem may exist with the payers themselves. The next step to identifying the source of the revenue decline may be to investigate the rate of collection, which may be a billing service responsibility.

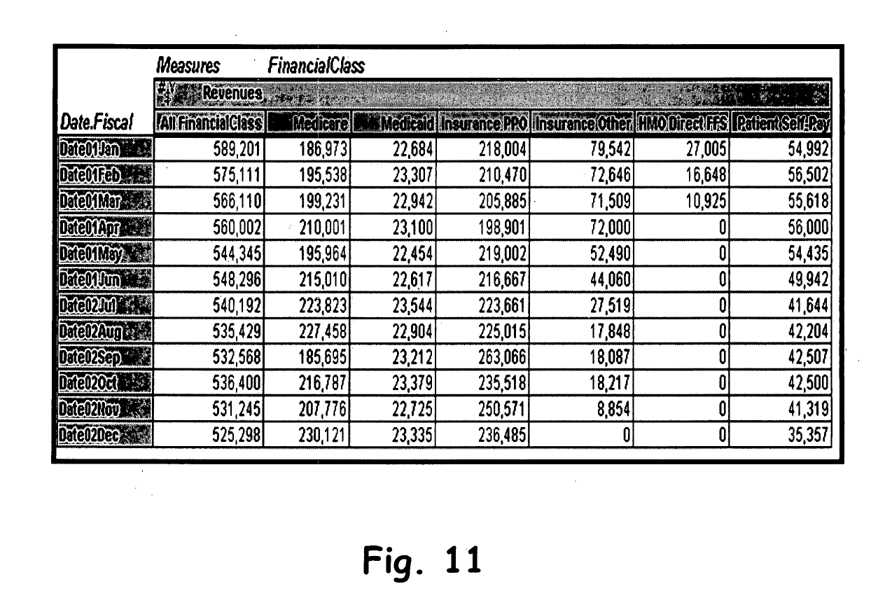

FIG. 12 is a screen shot of collection rates, according to an exemplary embodiment. This view may be created by rolling up the Date Fiscal dimension, dragging the Financial Class Name level of the Financial Class dimension into the rows area, and dragging the Charges and Collection Rate measures into the Columns Area. The time in the Date Fiscal dimension may be rolled up in order to cover the given time period as an aggregate. As a result, FIG. 12 depicts the collection rates received by payers by Financial Class.

Experience in healthcare business suggests that collecting 60% of charges from Medicare and 33% of charges from Medicaid is normal even for effective billing services. However, a collection rate of 49% (circle added) for Insurance PPO payers is much below normal. If the revenue decline was a result of poor billing services, then below normal collection rates may not be limited to one type of claim. As such, the billing service may be ruled out as the source of the revenue decline. The declining revenues may be caused by one or more of the payers in the Insurance PPO category. The system 400 may be used to examine the collection rates for each payer.

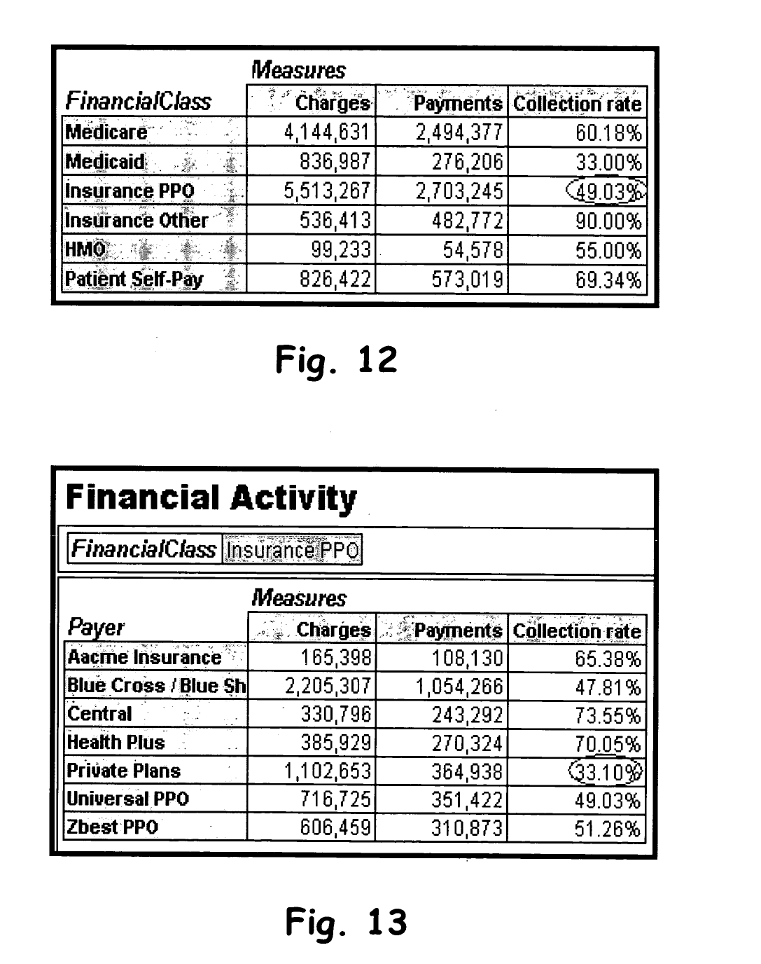

FIG. 13 is a screen shot of collection rates by payer, according to an exemplary embodiment. This view may be created by dragging the Financial Class Name level of the Financial Class dimension into the Filter Area and selecting Insurance PPO and by dragging the Payer Name level of the Payer dimension into the Rows Area. The resulting view depicted in FIG. 13 shows charges, payments, and collection rates for each Payer in the Insurance PPO category over the time period. Looking at the collection rates for each Payer, the practice may determine that the Payer called “Private Plans” is driving the revenue decline (circle added).

Since Private Plans does not pay well and is a significant portion of the Insurance PPO Financial Class, the practice may understand that if the Insurance PPO gains a greater share of the business, overall revenues of the practice may continue to decline. Knowing this information may allow the practice to address the problem effectively. For example, the practice may wish to renegotiate its contracts with the problem payer or entice more patients from more profitable sources.

As shown with reference to FIGS. 7-13, a practice can use the system 400 to evaluate their business operations and improve business performance. While the example above depicts how a practice may use the analytical data from the cubes 140 to evaluate revenue declines, the practice may use the analytical data in a variety of other ways.

### Other Financial Examples

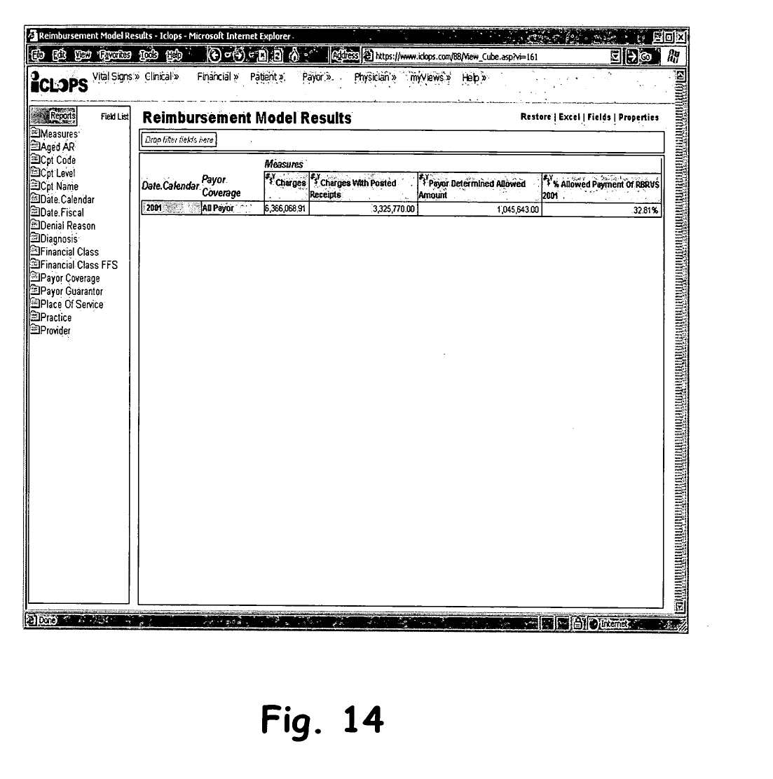

FIG. 14 is a screen shot of financial data, according to an exemplary embodiment. The system 400 may be used to help manage the business aspects of a physician practice in addition to patient care. The view depicted in FIG. 14 shows the following analytical data for the calendar year 2001:
Charges—What the practice charged for its rendered services
Charges with Posted Receipts—What the charges were for paid claims (but not how much was actually paid)
Payer Determined Allowed Amount—The total of what payers claimed was the contractually agreed upon price for charges that received payment.
% Allowed Payment of RBRVS—A comparison of the Payer Determined Allowed Amount with the Medicare reimbursement schedule for the same time period. Comparing to RBRVS provides a common standard to assess the value of different payers.

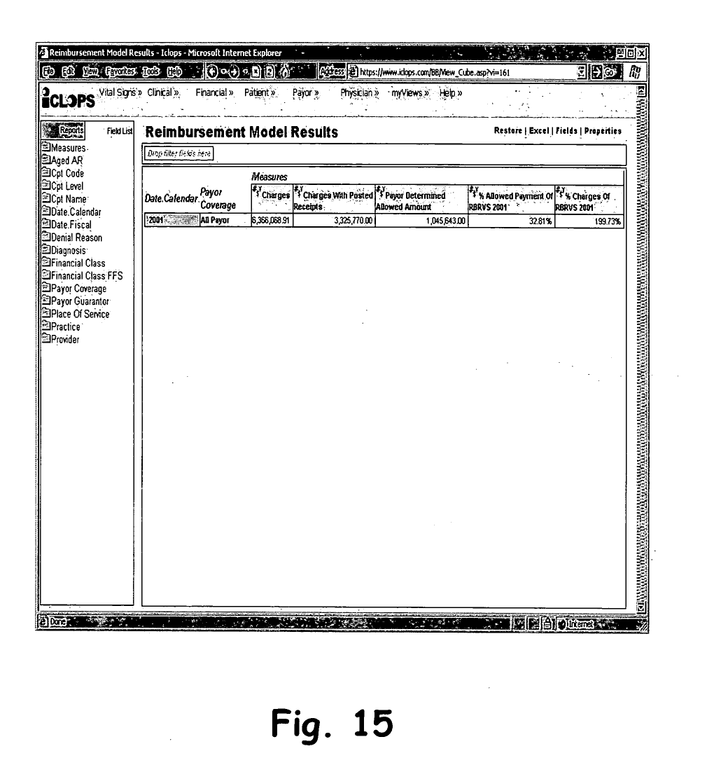

FIG. 15 is a screen shot of data shown in FIG. 14 including percent charges of RBRVS, according to an exemplary embodiment. This view may be created by dragging the % Charges of RBRVS into the Columns Area of the view. The resulting view depicted in FIG. 15 shows the following analytical data for the calendar year 2001:
Charges—What the practice charged for its rendered services
Charges with Posted Receipts—What the charges were for paid claims (but not how much was actually paid)
Payer Determined Allowed Amount—The total of what payers claimed was the contractually agreed upon price for charges that received payment.
% Allowed Payment of RBRVS—A comparison of the Payer Determined Allowed Amount with the Medicare reimbursement schedule for the same time period. Comparing to RBRVS provides a common standard to assess the value of different payers.
% Charges of RBRVS—A comparison of what the practice has charged as compared to the Medicare reimbursement schedule. This measure serves to put the practice charge schedule into a common context.

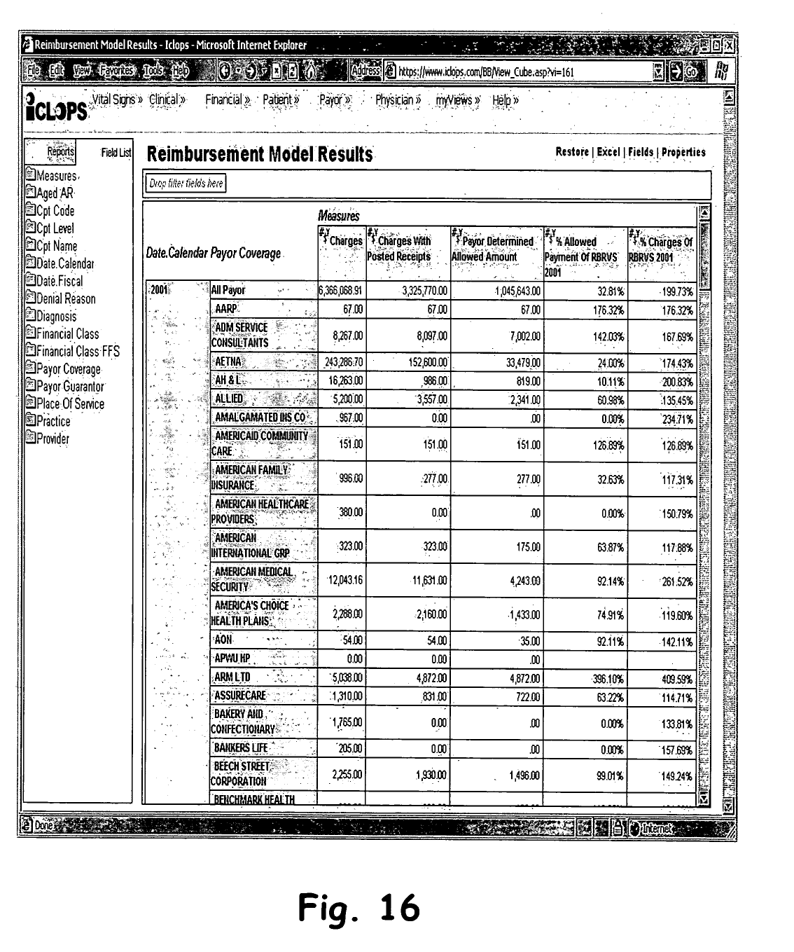

FIG. 16 is a screen shot of data shown in FIG. 15 by payer, according to an exemplary embodiment. This view was created by clicking on All Payer dimension already in the view. Since All Payer was at the top of a hierarchy of members, clicking on it expands the list to show all members at the next level. The members below All Payer include the list of all payers that have had charges claimed against them for 2001, and for those individual payers the view shows:
Charges—What the practice charged for its rendered services
Charges with Posted Receipts—What the charges were for paid claims (but not how much was actually paid)
Payer Determined Allowed Amount—The total of what payers claimed was the contractually agreed upon price for charges that received payment.
% Allowed Payment of RBRVS—A comparison of the Payer Determined Allowed Amount with the Medicare reimbursement schedule for the same time period. Comparing to RBRVS provides a common standard to assess the value of different payers.
% Charges of RBRVS—A comparison of what the practice has charged as compared to the Medicare reimbursement schedule. This measure serves to put the practice charge schedule into a common context.

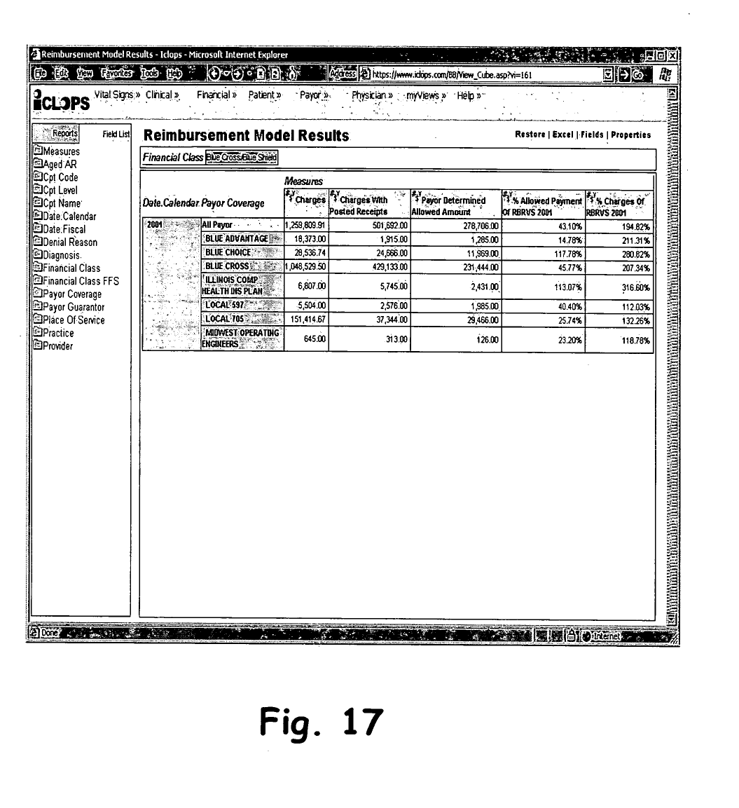

FIG. 17 is a screen shot of data shown in FIG. 16 by a selected financial class, according to an exemplary embodiment. This view may be created by dragging the Financial Class Name level of the Financial Class dimension into the Filter Area, and selecting to filter by Blue Cross.

The resulting view depicted in FIG. 17 shows the list of all payers in the Blue Cross financial class that have charges claimed against them for 2001, and for those individual payers the view shows:
Charges—What the practice charged for its rendered services
Charges with Posted Receipts—What the charges were for paid claims (but not how much was actually paid)
Payer Determined Allowed Amount—The total of what payers claimed was the contractually agreed upon price for charges that received payment.
% Allowed Payment of RBRVS—A comparison of the Payer Determined Allowed Amount with the Medicare reimbursement schedule for the same time period. Comparing to RBRVS provides a common standard to assess the value of different payers.
% Charges of RBRVS—A comparison of what the practice has charged as compared to the Medicare reimbursement schedule. This measure serves to put the practice charge schedule into a common context.

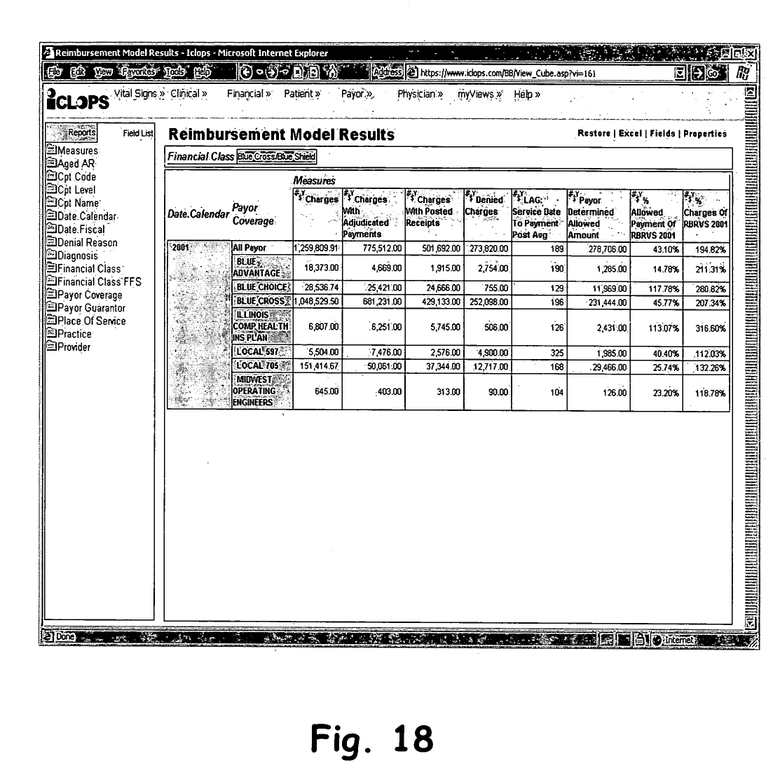

FIG. 18 is a screen shot of data shown in FIG. 17 including charges with adjudicated payments, denied charges, and payment lag, according to an exemplary embodiment. This view was created by dragging the Charges with Adjudicated Payments, Denied Charges, and Service to Payment Lag into the Columns Area. The resulting view depicted in FIG. 18 shows the list of all payers in the Blue Cross financial class that have had charges claimed against them for 2001, and for those individual payers the view shows:
Charges—What the practice charged for its rendered services
Charges with Posted Receipts—What the charges were for paid claims (but not how much was actually paid)
Payer Determined Allowed Amount—The total of what payers claimed was the contractually agreed upon price for charges that received payment.
% Allowed Payment of RBRVS—A comparison of the Payer Determined Allowed Amount with the Medicare reimbursement schedule for the same time period. Comparing to RBRVS provides a common standard to assess the value of different payers.
% Charges of RBRVS—A comparison of what the practice has charged as compared to the Medicare reimbursement schedule. This measure serves to put the practice charge schedule into a common context.
Charges with Adjudicated Payments—A total of the charges were had any kind of financial activity (payments, adjustments or denials).
Denied Charges—A total of the charges for claims denied by payers.
Service to Payment Lag—A count of how many days elapsed for the payers to send payment for claims, averaged over the time period.

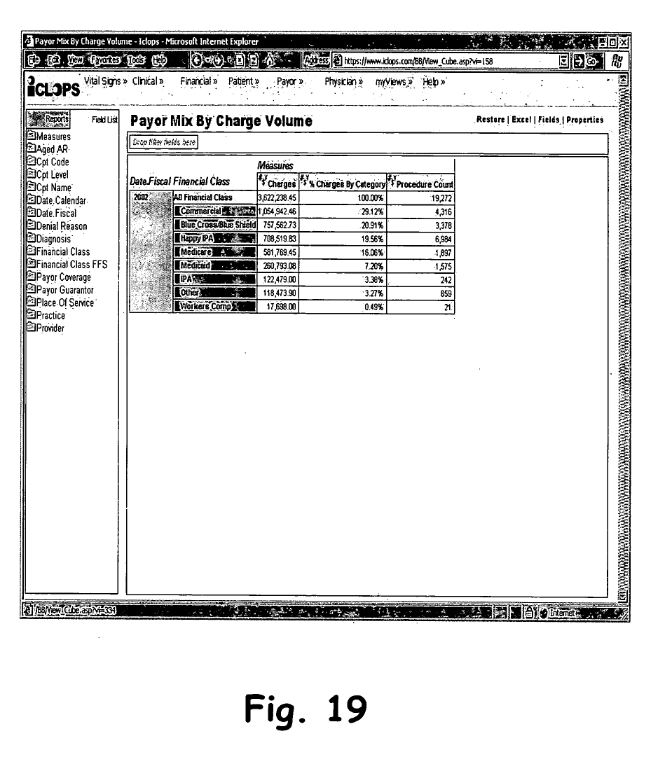

FIG. 19 is a screen shot of financial data, according to another exemplary embodiment. This initial view shows for year 2002 the Charges, number of procedures billed for, and the % of total charges for each financial class. This view may be used to evaluate the relative amounts of business a practice has with the various types of payers. This type of information is typically not readily available to practice managers.

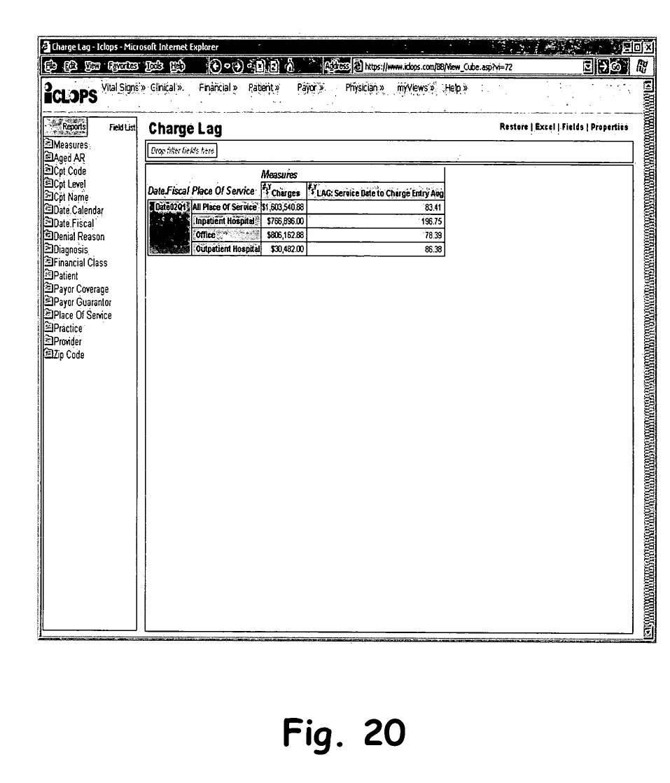

FIG. 20 is a screen shot of financial data, according to another exemplary embodiment. This is an initial view that shows the user how many days elapsed for charges to be entered into the billing system as reflected by different places of service. This view may allow a practice administrator to identify potential bottlenecks in the billing process as reflected by the differing operational procedures in the different places of service.

### Clinical Examples

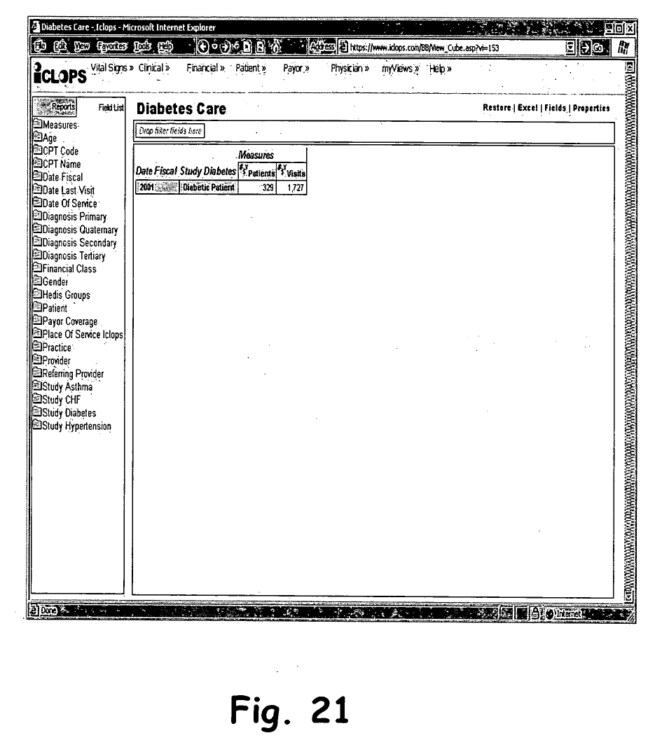

FIGS. 21-30 are screen shots of sample views of results using the system 400 depicted in FIG. 4. While the previous example demonstrated how a practice could use the system 400 to understand the financial nature of the practice's business, FIGS. 21-30 demonstrate how a practice can use the system 400 to understand the clinical nature of the practice's business.

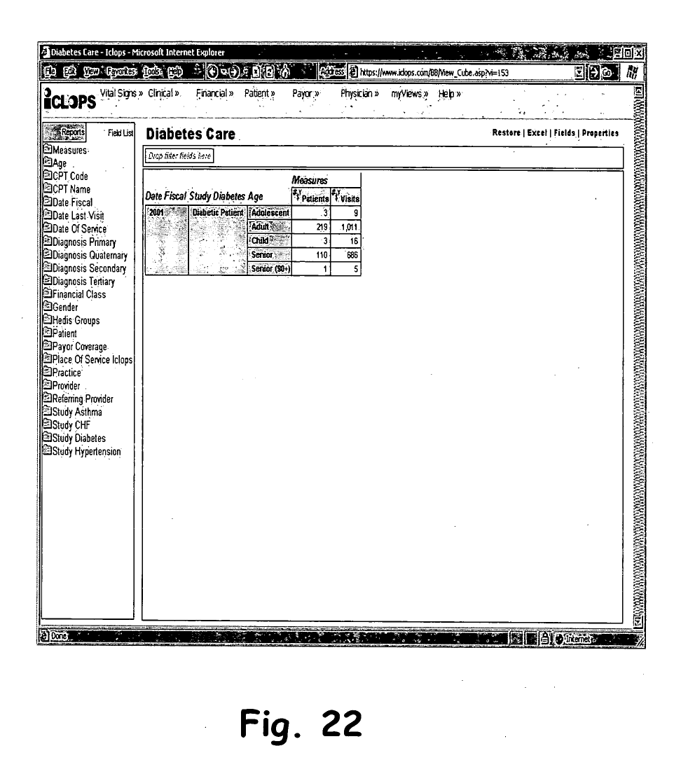

FIG. 21 is a screen shot of a number of diabetic patients and a number of visits these patients made to a practice in a given time, according to an exemplary embodiment. While the example provides analytic data regarding diabetic patients, it is understood that the system 400 may analyze patient data for a variety of medical diagnosis. This view may be created by dragging the Patient Visit Count measure into the Columns Area. The resulting view depicted in FIG. 21 may answer the practice's question regarding how many patients the practice has seen with a particular diagnosis and how many times they have visited the practice within a given time frame. This information may allow a physician to readily track and manage the care received by these patients. FIGS. 22-30 show a progression of analyses as performed by the system 400.

FIG. 22 is a screen shot of data shown in FIG. 21 separated by age category, according to an exemplary embodiment. This view may be created by dragging the Age Group level of the Age dimension into the Rows Area to show the distribution of the Diabetic patients by age group. The age groups in the Age dimension may be fully customizable.

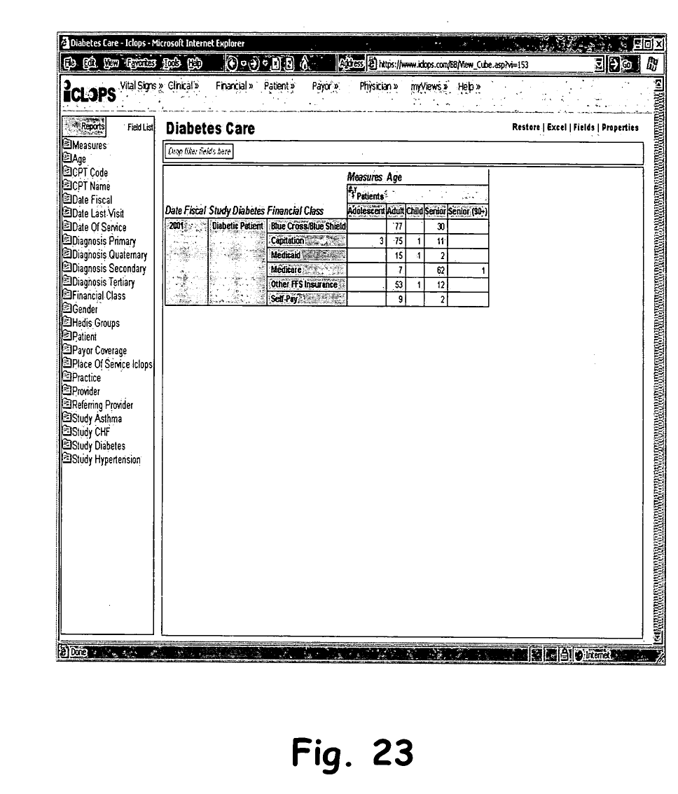

FIG. 23 is a screen shot of data shown in FIG. 22 separated by financial class, according to an exemplary embodiment. This view may be created by dragging the Patient Visit Count measure out of the Columns Area, dragging the Financial Class Name level of the Financial Class dimension into the Columns Area, and moving the Age dimension to the Columns Area. The resulting view depicted in FIG. 23, may provide the practice information regarding how the diabetic patients are distributed among age groups as well as what type of insurance coverage they had during 2001.

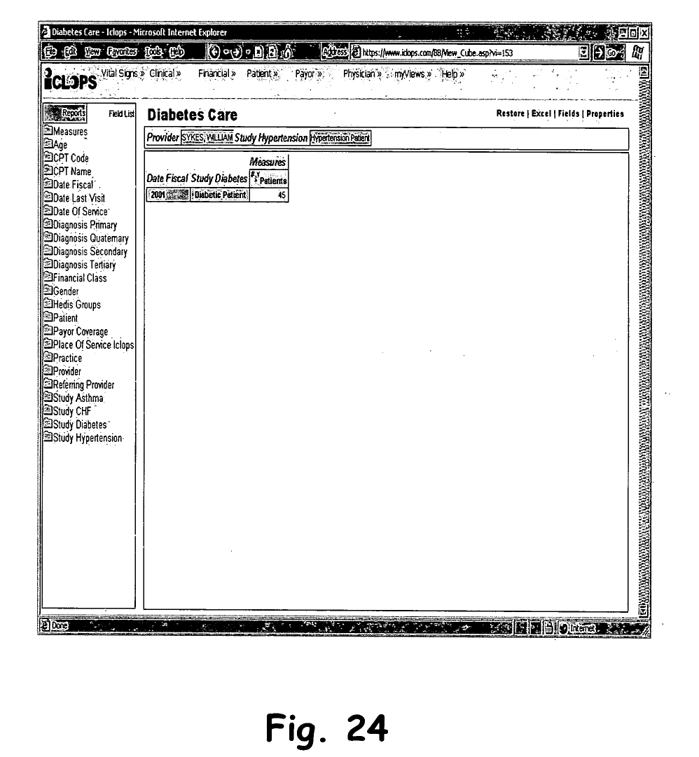

FIG. 24 is a screen shot of a number of diabetic patients that also suffer from hypertension, according to an exemplary embodiment. This view may be created by dragging both the Financial Class and Age dimensions from the Columns Area and dragging the Provider dimension and the Study Hypertension dimension into the Filter Area of the view. The Filter Area may allow users to select one or more members from a dimension to filter the query results accordingly. As depicted in FIG. 24, the user has filtered the data to show the count of diabetic patients of a doctor (i.e., William Sykes) who also suffer from hypertension for 2001.

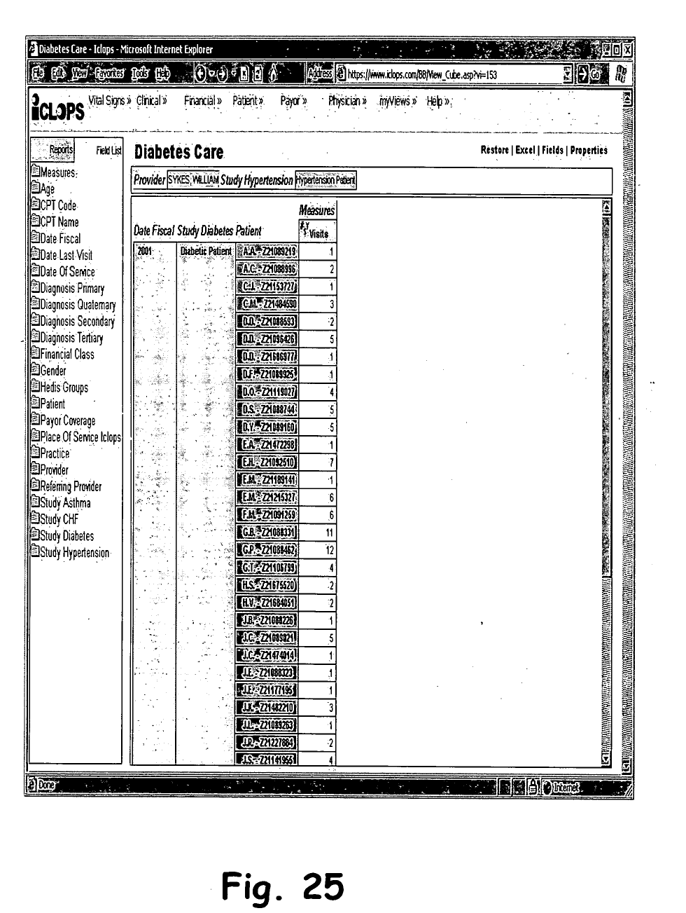

FIG. 25 is a screen shot listing diabetic patients that also suffer from hypertension and associated number of visits, according to an exemplary embodiment. This view may be created by dragging the Patient Name level of the Patient dimension into the Rows Area of the view, dragging the Visits Count measure into the Columns Area of the view, and dragging the Patient—Count measure out of the Columns Area. The resulting view depicted in FIG. 25 may allow the practice to receive data regarding individual patients. This view shows the diabetic patients by name and how many visits each patient had during 2001. The names of diabetic-hypertensive patients who had no visits in 2001 are not be listed in the view depicted in FIG. 25 as the system 400 may discard results with empty data.

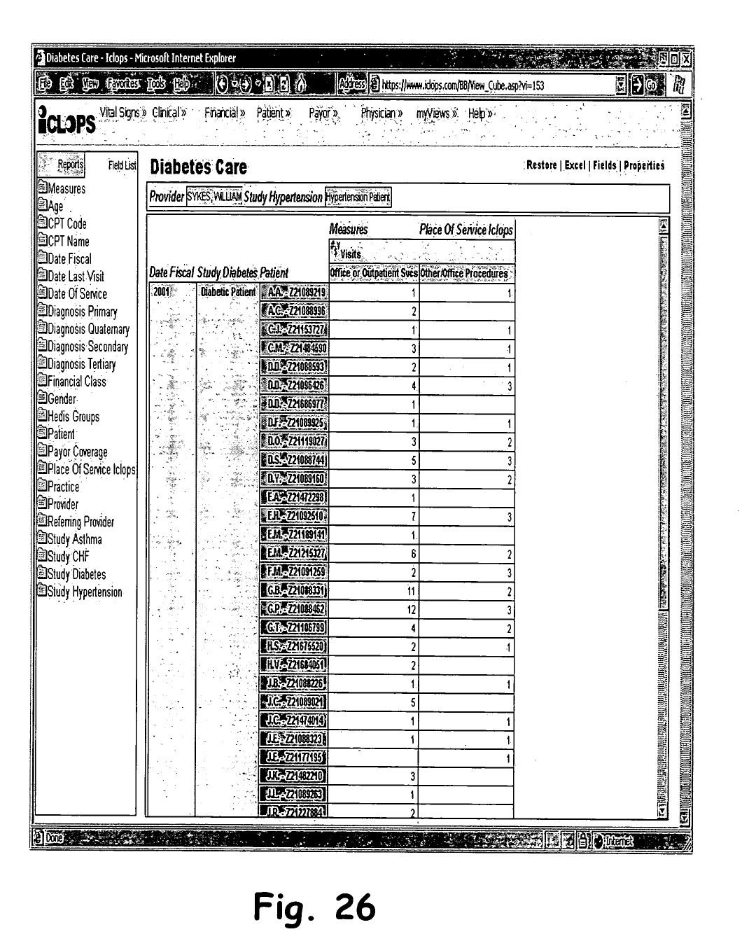

FIG. 26 is a screen shot listing place of service, according to an exemplary embodiment. This view may be created by dragging the Place of Service Group level of the Place of Service dimension into the Columns Area of the view. The Place of Service dimension is created based on the CPT codes indicative of particular possible places of service used for the visit. The resulting view depicted in FIG. 26 shows the diabetic-hypertensive patients by name and how many visits they each had, and the type of facility in which the visit occurred in during 2001. Analyzing the place of service may be important in gauging workflow or operational issues of the practice.

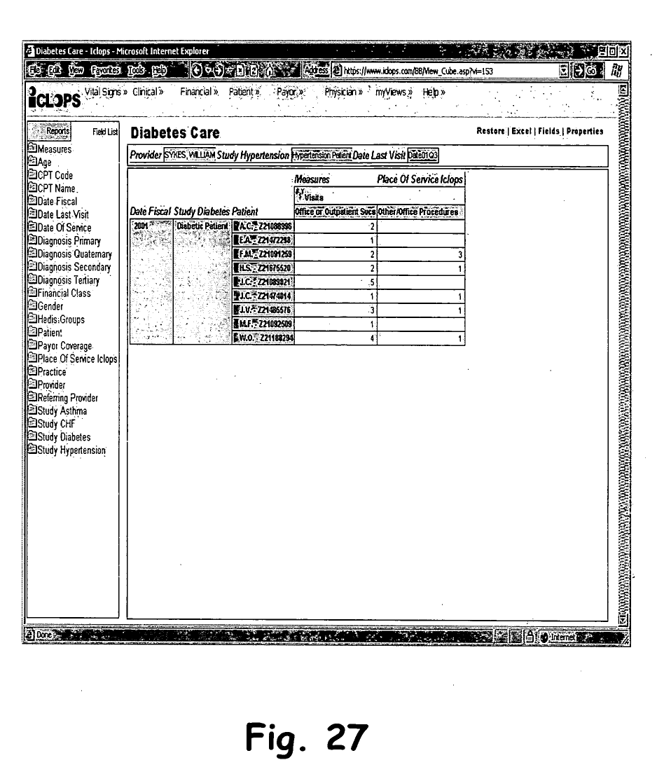

FIG. 27 is a screen shot of data shown in FIG. 26 for patients that visited a practice in the last two quarters, according to an exemplary embodiment. This view may be created by dragging the Quarter level of the Date of Last Visit dimension into the Filter Area, filtering for the time frame the two previous quarters to present in the view. The resulting view depicted in FIG. 27 shows the diabetic-hypertensive patients by name, how many visits they each had, and, the type of facility in which the visit occurred, all for the previous two quarters. Patients with chronic conditions require specific regimens of care and knowing when a patient was last seen can allow physicians to better manage those patient populations.

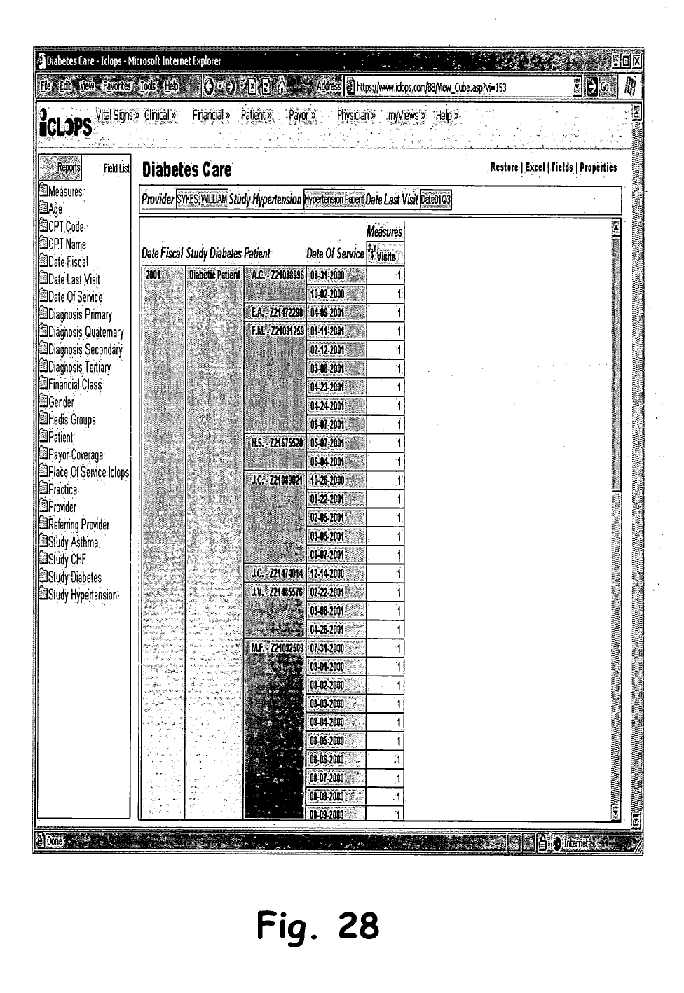

FIG. 28 is a screen shot of data shown in FIG. 27 including date of visit, according to an exemplary embodiment. This view may be created by dragging the Date level of the Date of Service dimension into the Rows Area right of Patient. The resulting view depicted in FIG. 28 shows the diabetic-hypertensive patients whose last visit was in the third quarter of 2001, by name, how many visits to the practice they each had, when they visited, and the type of facility in which the visit occurred.

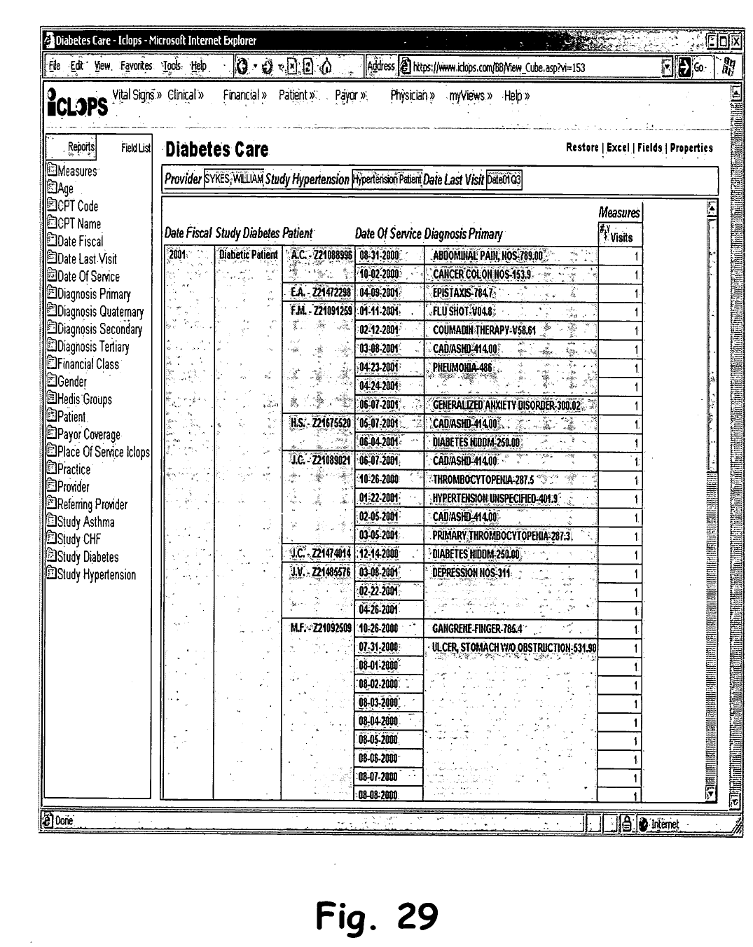

FIG. 29 is a screen shot of data shown in FIG. 28 including primary diagnosis, according to an exemplary embodiment. This view may be created by dragging the Diagnosis Name level of the Primary Diagnosis dimension into the Rows Area right of Date of Service. The resulting view depicted in FIG. 29 shows the diabetic-hypertensive patients whose last visit was in the third quarter of 2001, by name, how many visits they each had, what the primary diagnosis was, when they visited, and the type of facility in which the visit occurred.

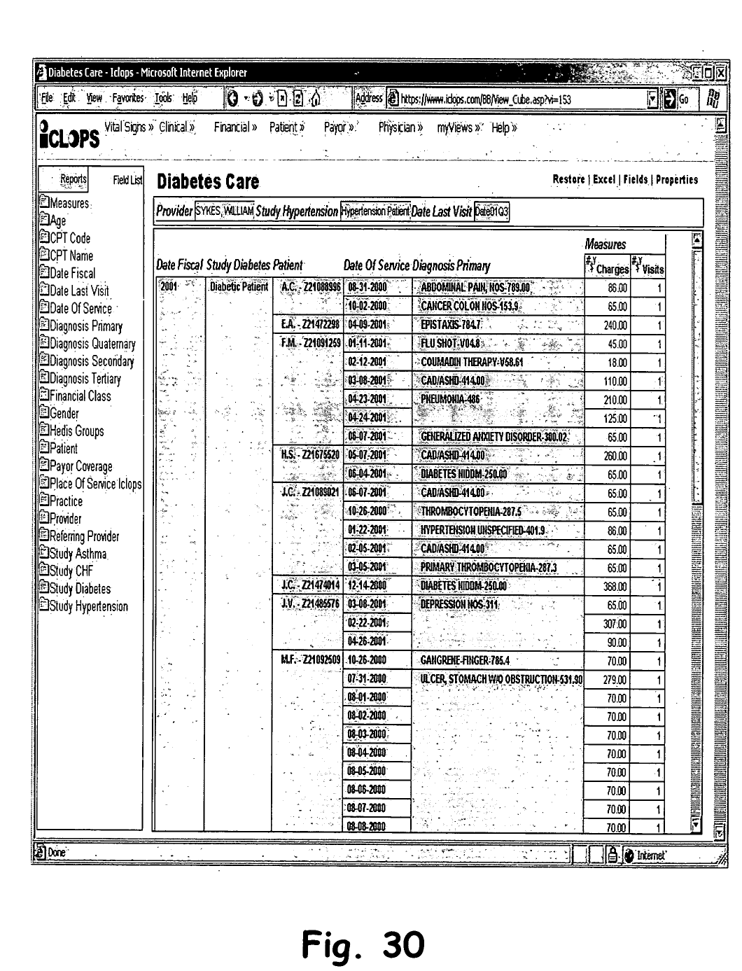

FIG. 30 is a screen shot of data shown in FIG. 29, including charge to patient, according to an exemplary embodiment. This view may be created by dragging the Charges measure into the Measures Area of the view. The resulting view depicted in FIG. 30 shows the diabetic-hypertensive patients whose last visit was in the third quarter of 2001, by name, how many visits they each had, what the primary diagnosis was, when they visited, what the amount charged was, and the type of facility in which the visit occurred.

As shown with reference to FIGS. 21-30, a practice can use the system 400 to evaluate their clinical business operations and improve business performance. While the example above depicts how a practice may use the analytical data from the cubes 140 to evaluate diabetic patients, the practice may use the analytical data in a variety of other ways.

In view of the wide variety of embodiments to which the principles of the present embodiments can be applied, it should be understood that the illustrated embodiments are exemplary only, and should not be taken as limiting the scope of the present invention.

We claim:

1. A system for data extraction and conversion of client data for use in business analysis tools, comprising in combination:
a staging database that receives the client data and thereafter quantifies the client data, wherein the client data is quantified by analytic definitions, wherein the analytic definitions are an identification of performance measures selected from the group consisting of account receivable levels, collections, coding, front-end billing processes, and payer values;
a clean database that receives the quantified data from the staging database and thereafter queries the quantified data to group data according to the analytic definitions;
one or more datamarts created by separating the grouped data received from the clean database according to the analytic definitions; and
one or more cubes created by processing the one or more datamarts using an on-line analytical processing engine, wherein the one or more cubes provide an analytical tool for evaluating business operations.

2. The system of claim 1, wherein the client data includes practice data, patient data, diagnosis data, insurance data, and transactional data.

3. The system of claim 1, wherein the account receivable levels analytic definition includes assessing whether an outstanding accounts receivable is at a reasonable level, assessing days in outstanding accounts receivable, and determining an accounts receivable trend.

4. The system of claim 1, wherein the collections analytic definition includes determining collection rates, denial rates, discounts, adjustments, and payment lag.

5. The system of claim 1, wherein the coding analytic definition includes determining whether evaluation and management coding is within expected levels, and determining a revenue opportunity for current procedural terminology codes.

6. The system of claim 1, wherein the front-end billing processes analytic definition includes quantifying charge lag, determining quality of payer data, identifying eligibility-related denials, identifying covered benefits-related denials, determining issues related to charge capture, and determining fee schedule quantities.

7. The system of claim 1, wherein the payer values analytic definition includes determining payer mix impact, observing varying collection rates, denial rates, contractual allowances by payer and financial class, and comparing payer reimbursement levels.

8. The system of claim 1, wherein the analytic definitions further include determining reimbursement rates per place of service compared with mix of place of services, determining visit volumes and reimbursements by physicians and locations, quantifying new visit volumes as a percentage of total visits, determining service mix and revenues by top current procedural terminology codes, quantifying patient collections, observing denial reasons lists, observing payer lists, determining place of service listings, and assessing patient billing processes.

9. The system of claim 1, wherein the one or more cubes are multidimensional databases.

10. The system of claim 1, wherein the one or more cubes are selected from the group consisting of financial cube, payer cube, patient cube, physician cube, clinical cube, and electronic medical records cube.

11. A system for data extraction and conversion of client data for use in clinical analysis tools, comprising in combination:
a staging database that receives the client data and thereafter quantifies the client data, wherein the client data is quantified by analytic definitions, wherein the analytic definitions are an identification of performance measures selected from the group consisting of identifying patients needing a return visit, identifying patients with risk factors, identifying patients with similar diagnosis, identifying patients with multiple diagnosis, analyzing referrals, determining clinical experience from different payer sources, determining adherence to quality measures, determining geographic distribution of patients, and tracking patients for lack of completion of ordered laboratory tests and referrals;
a clean database that receives the quantified data from the staging database and thereafter queries the quantified data to group data according to the analytic definitions;
one or more datamarts created by separating the grouped data received from the clean database according to the analytic definitions; and
one or more cubes created by processing the one or more datamarts using an on-line analytical processing engine, wherein the one or more cubes provide an analytical tool for evaluating clinical operations.

12. The system of claim 11, wherein the client data includes practice data, patient data, diagnosis data, insurance data, and transactional data.

13. The system of claim 11, wherein the one or more cubes are multidimensional databases.

14. The system of claim 11, wherein the one or more cubes are selected from the group consisting of financial cube, payer cube, patient cube, physician cube, clinical cube, and electronic medical records cube.

15. A method for data extraction and conversion of client data for use in business analysis tools, comprising in combination:
receiving client data;
creating a temporary database for storing the client data;
quantifying the client data, wherein the client data is quantified by analytic definitions, wherein the analytic definitions are an identification of performance measures selected from the group consisting of account receivable levels, collections, coding, front-end billing processes, and payer values;
creating a clean database that includes the quantified data, wherein the quantified data is queried to group data according to the analytic definitions;
creating one or more datamarts by separating data in the clean database according to the analytic definitions; and
creating one or more cubes by processing the datamarts the one or more datamarts using an on-line analytical processing engine, wherein the one or more cubes provide an analytical tool for evaluating business operations.

16. The method of claim 15, wherein the client data includes practice data, patient data, diagnosis data, insurance data, and transactional data.

17. The method of claim 15, wherein the account receivable levels analytic definition includes assessing whether an outstanding accounts receivable is at a reasonable level, assessing days in outstanding accounts receivable, and determining an accounts receivable trend.

18. The method of claim 15, wherein the collections analytic definition includes determining collection rates, denial rates, discounts, adjustments, and payment lag.

19. The method of claim 15, wherein the coding analytic definition includes determining whether evaluation and management coding is within expected levels, and determining a revenue opportunity for current procedural terminology codes.

20. The method of claim 15, wherein the front-end billing processes analytic definition includes quantifying charge lag, determining quality of payer data, identifying eligibility-related denials, identifying covered benefits-related denials, determining issues related to charge capture, and determining fee schedule quantities.

21. The method of claim 15, wherein the payer values analytic definition includes determining payer mix impact, observing varying collection rates, denial rates, contractual allowances by payer and financial class, and comparing payer reimbursement levels.

22. The method of claim 15, wherein the analytic definitions further include determining reimbursement rates per place of service compared with mix of place of services, determining visit volumes and reimbursements by physicians and locations quantifying new visit volumes as a percentage of total visits, determining service mix and revenues by top current procedural terminology codes, quantifying patient collections, observing denial reasons lists, observing payer lists, determining place of service listings, and assessing patient billing processes.

23. The method of claim 15, wherein the one or more cubes are multidimensional databases.

24. The method of claim 15, wherein the one or more cubes are selected from the group consisting of financial cube, payer cube, patient cube, physician cube, clinical cube, and electronic medical records cube.

25. A method for data extraction and conversion of client data for use in clinical analysis tools, comprising in combination:
receiving client data;
creating a temporary database for storing the client data;
quantifying the client data, wherein the client data is quantified by analytic definitions, wherein the analytic definitions are an identification of performance measures selected from the group consisting of identifying patients needing a return visit, identifying patients with risk factors, identifying patients with similar diagnosis, identifying patients with multiple diagnosis, analyzing referrals, determining clinical experience from different payer sources, determining adherence to quality measures, determining geographic distribution of patients, and tracking patients for lack of completion of ordered laboratory tests and referrals;
creating a clean database that includes the quantified data, wherein the quantified data is queried to group data according to the analytic definitions;
creating one or more datamarts by separating data in the clean database according to the analytic definitions; and
creating one or more cubes by processing the datamarts the one or more datamarts using an on-line analytical processing engine, wherein the one or more cubes provide an analytical tool for evaluating clinical operations.

26. The method of claim 25, wherein the client data includes practice data, patient data, diagnosis data, insurance data, and transactional data.

27. The method of claim 25, wherein the one or more cubes are multidimensional databases.

28. The method of claim 25, wherein the one or more cubes are selected from the group consisting of financial cube, payer cube, patient cube, physician cube, clinical cube, and electronic medical records cube.

29. A system for client access to analytical data for use in evaluating business operations, comprising in combination:
a client device operable to fetch and display a view;
a database server including
a system management database, wherein the system management database includes client authorization data, wherein the client authorization data includes a database record associated with each authorized user that indicates which menus, views, and databases are available to the authorized user; and
and one or more cubes having analytical data, wherein the analytical data is converted client data, wherein the client data is quantified by analytic definitions, wherein the analytic definitions are an identification of performance measures selected from the group consisting of account receivable levels, collections, coding, front-end billing processes, and payer values; and
a server including an application operable to receive a request from the client device for a view, select the requested view, verify that a user of the client device is authorized to: access the view by querying the database server, and if the user is authorized transmit the view to the client device, wherein the view includes the analytical data from the one or more cubes for use in evaluating business operations.

30. The system of claim 29, wherein the client device further includes an encryption/decryption utility for securely communicating with the server.

31. The system of claim 29, wherein server further includes an encryption/decryption utility for securely communicating with the client device.

32. The system of claim 29, wherein the database record further includes a query code that specifies an initial view to be displayed to the user.

33. The system of claim 29, wherein the client data includes practice data, patient data, diagnosis data, insurance data, and transactional data.

34. The system of claim 29, wherein the account receivable levels analytic definition includes assessing whether an outstanding accounts receivable is at a reasonable level, assessing days in outstanding accounts receivable, and determining an accounts receivable trend.

35. The system of claim 29, wherein the collections analytic definition includes determining collection rates, denial rates, discounts, adjustments, and payment lag.

36. The system of claim 29, wherein the coding analytic definition includes determining whether evaluation and management coding is within expected levels, and determining a revenue opportunity for current procedural terminology codes.

37. The system of claim 29, wherein the front-end billing processes analytic definition includes quantifying charge lag, determining quality of payer data, identifying eligibility-related denials, identifying covered benefits-related denials, determining issues related to charge capture, and determining fee schedule quantities.

38. The system of claim 29, wherein the payer values analytic definition includes determining payer mix impact, observing varying collection rates, denial rates, contractual allowances by payer and financial class, and comparing payer reimbursement levels.

39. The system of claim 29, wherein the analytic definitions further include determining reimbursement rates per place of service, compared with mix of place of services, determining visit volumes and reimbursements by physicians and locations, quantifying new visit volumes as a percentage of total visits, determining service mix and revenues by top current procedural terminology codes, quantifying patient collections, observing denial reasons lists, observing payer lists, determining place of service listings, and assessing patient billing processes.

40. The system of claim 29, wherein the one or more cubes are multidimensional databases.

41. The system of claim 29, wherein the one or more cubes are selected from the group consisting of financial cube, payer cube, patient cube, physician cube, clinical cube, and electronic medical records cube.

42. A system for client access to analytical data for use in evaluating clinical operations, comprising in combination:
a client device operable to fetch and display a view;
a database server including
a system management database, wherein the system management database includes client authorization data, wherein the client authorization data includes a database record associated with each authorized user that indicates which menus, views, and databases are available to the authorized user; and
and one or more cubes having analytical data, wherein the analytical data is converted client data, wherein the client data is quantified by analytic definitions, wherein the analytic definitions are an identification of performance measures selected from the group consisting of identifying patients needing a return visit, identifying patients with risk factors, identifying patients with similar diagnosis, identifying patients with multiple diagnosis, analyzing referrals, determining clinical experience from different payer sources, determining adherence to quality measures, determining geographic distribution of patients, and tracking patients for lack of completion of ordered laboratory tests and referrals; and
a server including a application operable to receive a request from the client device for a view, select the requested view, verify that a user of the client device is authorized to access the view by querying the database server, and if the user is authorized transmit the view to the client device, wherein the view includes the analytical data from the one or more cubes for use in evaluating clinical operations.

43. The system of claim 42, wherein the client device further includes an encryption/decryption utility for securely communicating with the server.

44. The system of claim 42, wherein server further includes an encryption/decryption utility for securely communicating with the client device.

45. The system of claim 42, wherein the database record further includes a query code that specifies an initial view to be displayed to the user.

46. The system of claim 42, wherein the client data includes practice data, patient data, diagnosis data, insurance data, and transactional data.

47. The system of claim 42, wherein the one or more cubes are multidimensional databases.

48. The system, of claim 42, wherein the one or more cubes are selected from the group consisting of financial cube, payer cube, patient cube, physician cube, clinical cube, and electronic medical records cube.

49. A method of accessing analytical data for use in evaluating business operations, comprising in combination:
receiving a request from a user to access the analytical data, wherein the analytical data is converted client data, wherein the client data is quantified by analytic definitions, wherein the analytic definitions are an identification of performance measures selected from the group consisting of account receivable levels, collections, coding, front-end billing processes, and payer values;
verifying credentials of the user;
determining extent of access of the user having proper credentials;
displaying an initial view assigned to the user, wherein the initial view provides a list of fields illustrating contents of a cube being used by the initial view; and
modifying the view in response to the user selecting options from the list of fields, wherein the view displays the analytical data for evaluating business operations.

50. The method of claim 49, wherein the user requests access to the analytical data from a web page.

51. The method of claim 50, wherein the user requests access to the analytical data by entering credentials on a logon form on the web page.

52. The method of claim 51, wherein a web server compares the credentials with data in a system management database.

53. The method of claim 52, wherein if the credentials do not match the data in the system management database, an error message is transmitted to the user.

54. The method of claim 49, wherein determining the extent of access is performed by reading a database record associated with the user, wherein the database record dictates which menus, views, and databases are available to the user.

55. The method of claim 49, wherein the options are selected from the group consisting of selecting and opening another pre-written view from a user menu, regenerating a current pre-written view, displaying a query code used to generate a view, exporting contents of the view to another application, hiding the list of fields, exposing the list of fields, modifying the view, saving a modified view, and exiting.

56. The method of claim 49, wherein the client data includes practice data, patient data, diagnosis data, insurance data, and transactional data.

57. The method of claim 49, wherein the account receivable levels analytic definition includes assessing whether an outstanding accounts receivable is at a reasonable level, assessing days in outstanding accounts receivable, and determining an accounts receivable trend.

58. The method of claim 49, wherein the collections analytic definition includes determining collection rates, denial rates, discounts, adjustments, and payment lag.

59. The method of claim 49 wherein the coding analytic definition includes determining whether evaluation and management coding is within expected levels, and determining a revenue opportunity for current procedural terminology codes.

60. The method of claim 49, wherein the front-end billing processes analytic definition includes quantifying charge lag, determining quality of payer data, identifying eligibility-related denials, identifying covered benefits-related denials, determining issues related to charge capture, and determining fee schedule quantities.

61. The method of claim 49, wherein the payer values analytic definition includes determining payer mix impact, observing varying collection rates, denial rates, contractual allowances by payer and financial class, and comparing payer reimbursement levels.

62. The method of claim 49, wherein the analytic definitions further include determining reimbursement rates per place of service compared with mix of place of services, determining visit volumes and reimbursements by physicians and locations, quantifying new visit volumes as a percentage of total visits, determining service mix and revenues by top current procedural terminology codes, quantifying patient collections, observing denial reasons lists, observing payer lists, determining place of service listings, and assessing patient billing processes.

63. A method of accessing analytical data for use in evaluating clinical operations, comprising in combination:
receiving a request from a user to access the analytical data, wherein the analytical data is converted client data, wherein the client data is quantified by analytic definitions, wherein the analytic definitions are an identification of performance measures selected from the group consisting of identifying patients needing a return visit, identifying patients with risk factors, identifying patients with similar diagnosis, identifying patients with multiple diagnosis, analyzing referrals, determining clinical experience from different payer sources, determining adherence to quality measures, determining geographic distribution of patients, and tracking patients for lack of completion of ordered laboratory tests and referrals;
verifying credentials of the user;
determining extent of access of the user having proper credentials;
displaying an initial view assigned to the user, wherein the initial view provides a list of fields illustrating contents of a cube being used by the initial view; and
modifying the view in response to the user selecting options from the list of fields, wherein the view displays the analytical data for evaluating clinical operations.

64. The method of claim 63, wherein the user requests access to the analytical data from a web page.

65. The method of claim 64, wherein the user requests access to the analytical data by entering credentials on a logon form on the web page.

66. The method of claim 65, wherein a web server compares the credentials with data in a system management database.

67. The method of claim 66, wherein if the credentials do not match the data in the system management database, an error message is transmitted to the user.

68. The method of claim 63, wherein determining the extent of access is performed by reading a database record associated with the user, wherein the database record dictates which menus, views, and databases are available to the user.

69. The method of claim 63, wherein the options are selected from the group consisting of selecting and opening another pre-written view from a user menu, regenerating a current pre-written view, displaying a query code used to generate a view, exporting contents of the view to another application, hiding the list of fields, exposing the list of fields, modifying the view, saving a modified view, and exiting.

70. The method of claim 63, wherein the client data includes practice data, patient data, diagnosis data, insurance data, and transactional data.
